(19) United States
(12) Patent Application Publication
(10) Pub. No.: US 2016/0194561 A1
(43) Pub. Date: Jul. 7, 2016

(54) DIFLUOROPHENYL LIQUID CRYSTAL COMPOSITION

(71) Applicant: DIC CORPORATION, Tokyo (JP)

(72) Inventors: Toru Fujisawa, Kita-adachi-gun (JP); Kazuaki Hatsusaka, Kita-adachi-gun (JP); Kazunori Maruyama, Kita-adachi-gun (JP); Isa Nishiyama, Kita-adachi-gun (JP)

(73) Assignee: DIC Corporation, Tokyo (JP)

(21) Appl. No.: 14/894,203

(22) PCT Filed: Mar. 23, 2014
(86) PCT No.: PCT/JP2014/063697

§ 371 Date: Feb. 5, 2016

(30) Foreign Application Priority Data
May 31, 2013 (JP) 2013-115482

(51) Int. Cl. C09K 19/54; C09K 19/12; C09K 19/30

(52) U.S. Cl. CPC C09K 19/542; C09K 19/3001; C09K 19/12; C09K 2019/123; C09K 2019/548

(57) ABSTRACT

The present invention provides a novel liquid crystal composition which exhibits a smectic C* phase and in which a fluorine-substituent-introduced liquid crystal compound that exhibits a smectic C* phase is used to enhance the reliability of a liquid crystal device driven by a TFT and to decrease the melting point thereof for expansion of the operation temperature of the liquid crystal device.

The liquid crystal composition of the present invention contains at least two liquid crystal compounds each containing a mesogenic group having at least three rings of which at least one is a 2,3-difluorobenzene-1,4-diyl group and two terminal groups having different structures, wherein a compound having a pyrimidine skeleton is not used.

### TECHNICAL FIELD

The present invention relates to a liquid crystal composition which is useful as a material for a liquid crystal display and which exhibits a smectic C* phase in a wide temperature range.

### BACKGROUND ART

Liquid crystal display devices have been applied to, for example, watches, calculators, a variety of measuring equipment, panels used in automobiles, word processors, electronic notebooks, printers, computers, television sets, clocks, and advertising boards.

Representative examples of types of liquid crystal display devices include a TN (twisted nematic) type, an STN (super twisted nematic) type, and vertical alignment and IPS (in-plane switching) types involving use of a TFT (thin film transistor). Liquid crystal compositions used in such liquid crystal display devices need to satisfy the following requirements: being stable to external stimuli such as moisture, air, heat, and light; having a liquid crystal phase in a wide temperature range mainly including room temperature as much as possible; having a low viscosity; and enabling a low driving voltage. In addition, liquid crystal compositions are composed of several to tens of compounds in order to adjust, for example, the dielectric anisotropy (Δ∈) and/or refractive index anisotropy (Δn) to be optimum to individual display devices. A VA (vertical alignment) type in which nematic liquid crystal having a negative dielectric anisotropy is used has been widely used for liquid crystal television sets. A TN type in which nematic liquid crystal having a positive dielectric anisotropy is used has been widely used for the monitors of personal computers.

Meanwhile, since smartphone and tablet computer markets have been quickly expanding in recent years, a demand for LCDs that can serve as touch panels has increased in the markets. Demand characteristics for such LCDs that can serve as touch panels include display unchangeable in the operation of touch panels, high quality of high-resolution display, and quick response. The demand characteristic of display unchangeable in the operation of touch panels is difficult to be achieved in a VA type because touching with a finger changes the alignment, and another display type such as an IPS type or an FFS type is therefore employed.

In terms of quick response that is one of the demand characteristics of LCDs that can serve as touch panels, a response speed of not more than 1 msec has been needed for three-dimensional display that has been becoming popular these days. In order to achieve such quick response, a further reduction in the viscosity of nematic liquid crystal is necessary. In addition, development of a polymer-stabilized blue phase that is characterized in enabling high response speed of not more than 1 msec has been reported.

Such materials, however, give a narrow range of operation temperature and need high driving voltage, which causes a problem in which a liquid crystal material having a high dielectric anisotropy Δ∈ is needed.

Another liquid crystal material which enables quick response at not more than 1 msec is ferroelectric liquid crystal. Ferroelectric liquid crystal materials and devices using the same were intensively developed before TFT driving became practical; now, LCDs driven by TFTs are practically used, and thus development thereof is not common. Ferroelectric liquid crystal, however, has great advantages of quick response and a memory property, and further development thereof is expected. A ferroelectric liquid crystal material which has been developed is mainly pyrimidine liquid crystal (e.g., see Patent Literatures 1 to 4). Pyrimidine liquid crystal materials have a low specific resistance and are therefore unfortunately unsuitable for TFT driving.

Hence, a new ferroelectric liquid crystal composition other than a pyrimidine liquid crystal material needs to be developed, and development of a composition that exhibits a liquid crystal phase in a wide temperature range is expected.

In order to control the crystallization temperature of a liquid crystal composition to be not more than −10° C., a bicyclic liquid crystal having a narrow temperature range of liquid crystal is generally added; however, use of a bicyclic liquid crystal causes a problem in which the upper limit of temperature of a liquid crystal phase becomes low. A tri- or higher cyclic liquid crystal can be added to solve this problem, but the number of materials used in a liquid crystal composition is increased, which results in increased production costs. In smectic liquid crystal, its phase sequence needs to be controlled to enable molecular alignment, and the temperature range of a smectic C* phase needs to be expanded; hence, a lot of liquid crystal compounds that exhibit a smectic phase are used into complexed composition, which is problematic. In particular, in difluorophenyl liquid crystal, limited types of compounds exhibit a smectic C* phase, which makes it difficult to expand the temperature range of a smectic C* phase. Furthermore, since many of liquid crystal materials that exhibit a smectic C* phase are pyrimidine liquid crystal, an approach of increasing specific resistance without use of pyrimidine liquid crystal is difficult; thus, such an approach is unsuitable for TFT driving.

### CITATION LIST

### Patent Literature

PTL 1: U.S. Pat. No. 5,124,068

PTL 2: Japanese Unexamined Patent Application Publication (Translation of PCT Application) No. 62-501361

PTL 3: U.S. Pat. No. 5,286,409

PTL 4: Japanese Unexamined Patent Application Publication (Translation of PCT Application) No. 04-503826

### SUMMARY OF INVENTION

### Technical Problem

It is an object of the present invention to provide a novel liquid crystal composition which exhibits a smectic C* phase and in which a fluorine-substituent-introduced liquid crystal compound that exhibits a smectic C* phase is used to enhance the reliability of a liquid crystal device driven by a TFT and to decrease the melting point thereof for expansion of the operation temperature of the liquid crystal device.

### Solution to Problem

The inventor has studied a variety of liquid crystal compounds and chemical substances and found that a combination of specific liquid crystal compounds enables the above-mentioned object to be achieved, thereby accomplishing the present invention. In particular, the first aspect of the present invention provides the following liquid crystal composition, and the second aspect of the present invention provides the following liquid crystal device.

[1]A liquid crystal composition containing at least two liquid crystal compounds each containing a mesogenic group having at least three rings of which at least one is a 2,3-difluorobenzene-1,4-diyl group and two terminal groups having different structures, wherein a compound having a pyrimidine skeleton is not used.

[2] The liquid crystal composition according to the aspect [1], wherein the mesogenic group of each of the liquid crystal compounds is represented by General Formula (I)

[Chem. 1]

-(A¹-Z¹)ₘ-(A²-Z²)ₙ-A³- (I)

(in the formula, A¹, A², and A³ each independently represent a 2,3-difluorobenzene-1,4-diyl group, a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, or a fluorene-2,7-diyl group;

at least one of A¹, A², and A³ represents a 2,3-difluorobenzene-1,4-diyl group;

the 1,4-phenylene group, the 1,2,3,4-tetrahydronaphthalene-2,6-diyl group, the 2,6-naphthylene group, the phenanthrene-2,7-diyl group, the 9,10-dihydrophenanthrene-2,7-diyl group, the 1,2,3,4,4a,9,10a-octahydrophenanthrene-2,7-diyl group, and the fluorene-2,7-diyl group each optionally have at least one of F, CF₃, OCF₃, and CH₃ as a substituent;

Z¹ and Z² each independently represent —O—, —CO—, —COO—, —CF₂O—, —OCF₂—, —OCO—, —CH₂CH₂—, —O—CH₂—, —CH₂O—, —CH═CH—, —C≡C—, —CF₂CF₂—, or a single bond; and

n and m each represent 1 or 2)

[3] The liquid crystal composition according to any one of the aspects [1] and [2], wherein the mesogenic group of each of the liquid crystal compounds is at least one selected from the group consisting of a 2′,3′-difluoroterphenyl group, a 2,3-difluoroterphenyl group, and a 2″,3″-difluoroterphenyl group.

[4] The liquid crystal composition according to any one of the aspects [1] to [3], wherein a liquid crystal compound containing a 2′,3′-difluoroterphenyl group as the mesogenic group and a liquid crystal compound containing a 2,3-difluoroterphenyl group as the mesogenic group are used, and

the liquid crystal compound containing a 2′,3′-difluoroterphenyl group and the liquid crystal compound containing a 2,3-difluoroterphenyl group have a difference in at least one of the two terminals each other.

[5] The liquid crystal composition according to any one of the aspects [1] to [3], wherein at least two liquid crystal compounds each containing a 2′,3′-difluoroterphenyl group as the mesogenic group are used.

[6] The liquid crystal composition according to any one of the aspects [1] to [5], wherein the terminal groups of each of the liquid crystal compounds are each a hydrogen atom or a linear or branched alkyl group having 1 to 20 carbon atoms; one —CH₂— moiety or at least two —CH₂— moieties not adjoining each other in the alkyl group are each independently optionally substituted with —CH═CH—, —C≡C—, —O—, —CO—, —COO—, —OCO—, or a cyclohexylene group; one or more hydrogen atoms in the alkyl group are each independently optionally substituted with a fluorine atom; and

among the —CH₂— moieties of the terminal groups, a —CH₂— moiety which is distant from the mesogenic group with at least four atoms interposed between them is optionally substituted with a 1,4-cyclohexylene group, a 1,4-phenylene group, a 1,4-bicyclo(2,2,2)octylene group, or a dialkylsilylene group.

[7] The liquid crystal composition according to the aspect [6], wherein at least one of the terminal groups of each of the liquid crystal compounds is an alkyl group having 4 to 15 carbon atoms or an alkoxyl group having 4 to 15 carbon atoms.

[8] The liquid crystal composition according to any one of the aspects [1] to [7], wherein the composition exhibits a smectic phase as a liquid crystal phase.

[9] The liquid crystal composition according to any one of the aspects [1] to [8], further containing at least one compound containing an optically active substance.

[10] The liquid crystal composition according to any one of the aspects [1] to [9], further containing at least one compound having a polymerizable functional group.

[11]A liquid crystal display device including the liquid crystal composition according to any one of the aspects [1] to [10].

### Advantageous Effects of Invention

The liquid crystal composition provided according to the present invention is composed of only tricyclic liquid crystal compounds without use of bicyclic liquid crystal compounds having a narrow temperature range of a liquid crystal phase and has a wider temperature range of liquid crystal, in which the crystallization temperature is not more than −10° C., as compared with typical liquid crystal compositions. Since pyrimidine liquid crystal is not used, the liquid crystal composition enables high response speed and an enhancement in specific resistance that needs in TFT driving, which gives enhanced reliability. Furthermore, such a liquid crystal composition contains the reduced number of components, so that the prices of products can be decreased.

The liquid crystal composition of the present invention has a low crystallization temperature, a broad temperature range of smectic liquid crystal, and low viscosity; thus, the liquid crystal composition is particularly highly practical (adaptable) for smectic liquid crystal and is therefore greatly useful.

### DESCRIPTION OF EMBODIMENTS

[Liquid Crystal Composition]

The liquid crystal composition of the present invention is free from a compound having a pyrimidine skeleton but contains at least two liquid crystal compounds each having a mesogenic group which has three or more rings of which at least one is a 2,3-difluorobenzene-1,4-diyl group and having two terminal groups which have different structures. Use of the liquid crystal compounds each containing a 2,3-difluorobenzene-1,4-diyl group enables an enhancement in specific resistance, which imparts high reliability to a liquid crystal display device driven by a TFT.

The mesogenic group of each of the above-mentioned liquid crystal compounds consists of rings and linking groups that connect the rings; in particular, the mesogenic group has three or more rings connected by linking groups of which the number of atoms is two or less.

The mesogenic group contained in each of the liquid crystal compounds preferably has a structure represented by General Formula (I).

[Chem. 2]

-(A¹-Z¹)ₘ-(A²-Z²)ₙ-A³- (I)

(in the formula, A¹, A², and A³ each independently represent a 2,3-difluorobenzene-1,4-diyl group, a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, or a fluorene-2,7-diyl group;

at least one of A¹, A², and A³ represents a 2,3-difluorobenzene-1,4-diyl group;

the 1,4-phenylene group, the 1,2,3,4-tetrahydronaphthalene-2,6-diyl group, the 2,6-naphthylene group, the phenanthrene-2,7-diyl group, the 9,10-dihydrophenanthrene-2,7-diyl group, the 1,2,3,4,4a,9,10a-octahydrophenanthrene-2,7-diyl group, and the fluorene-2,7-diyl group each optionally have at least one of F, CF₃, OCF₃, and CH₃ as a substituent;

Z¹ and Z² each independently represent —O—, —CO—, —COO—, —CF₂O—, —OCF₂—, —OCO—, —CH₂CH₂—, —O—CH₂—, —CH₂O—, —CH═CH—, —C≡C—, —CF₂CF₂—, or a single bond; and

n and m each represent 1 or 2)

A¹, A², A³, Z¹, and Z² are preferably selected on the basis of the intended liquid crystal phase, temperature range of the phase, phase sequence, and melting point.

In other words, the liquid crystal composition of the present invention preferably contains at least two liquid crystal compounds each having a group represented by General Formula (I). Preferred embodiments of the liquid crystal composition of the present invention will now be described in detail.

The term “%” in the following compositions refers to “mass %” unless otherwise specified.

The liquid crystal composition of the present invention preferably contains at least two compounds represented by General Formula (i).

[Chem. 3]

Rⁱ¹-(A¹-Z¹)ₘ-(A²-Z²)ₙ-A³-Rⁱⁱ¹ (i)

(in the formula, Rⁱ¹ and Rⁱⁱ¹ each independently represent a hydrogen atom or a linear or branched alkyl group having 1 to 20 carbon atoms; one —CH₂— moiety or at least two —CH₂— moieties not adjoining each other in the alkyl group are each independently optionally substituted with —CH═CH—, —C≡C—, —O—, —CO—, —COO—, —OCO—, or a cyclohexylene group; one or more hydrogen atoms in the alkyl group are each independently optionally substituted with a fluorine atom; among the —CH₂— moieties of Rⁱ¹ and Rⁱⁱ¹, a —CH₂— moiety which is distant from the mesogenic group with at least four atoms interposed therebetween is optionally substituted with a 1,4-cyclohexylene group, a 1,4-phenylene group, a 1,4-bicyclo(2,2,2)octylene group, or a dialkylsilylene group; and A¹, Z¹, m, A², Z², n, and A³ have the same meanings as those in General Formula (I), respectively.

The compound represented by General Formula (i) has the mesogenic group of (A¹-Z¹)ₘ-(A²-Z²)ₙ-A³ and the two terminal groups of Rⁱ¹ and Rⁱⁱ¹.

In general, in a technique for reducing crystallization, a bicyclic liquid crystal having a low crystallization temperature and a tricyclic liquid crystal which exhibits a liquid crystal phase at high temperature are used in combination to expand the temperature range of a liquid crystal phase, thereby decreasing crystallization temperature. The liquid crystal composition of the present invention contains at least two tri- or higher cyclic liquid crystal compounds which can inhibit linearity; hence, the composition does not need to contain bicyclic liquid crystal. In particular, compounds having a difference in the structures of terminal groups are combined to cause steric hindrance resulting from the inhibited linearity of liquid crystal molecules, so that crystallization is suppressed and that crystallization temperature can be therefore decreased. Thus, according to the present invention, a liquid crystal composition in which the upper limit of the temperature of a nematic phase or smectic C* phase is high, that is, a liquid crystal composition in which the temperature range of a nematic phase or smectic C* phase is wide can be provided while low crystallization temperature is maintained.

The compound represented by General Formula (i) contains three or more rings, and preferably three or four rings. A preferred tricyclic liquid crystal compound is any of compounds represented by General Formula (i-1).

[Chem. 4]

Rⁱ¹-A¹-Z¹-A²-Z²-A³-Rⁱⁱ¹ (i-1)

(in the formula, Rⁱ¹, Rⁱⁱ¹, A¹, A², A³, Z¹, and Z² have the same meanings as those in General Formula (i), respectively)

In General Formula (i-1), Rⁱ¹ and Rⁱⁱ¹ are each independently preferably a linear or branched alkyl group having 1 to 12 carbon atoms, and also preferably an alkoxy group having 1 to 12 carbon atoms. At least one of Rⁱ¹ and Rⁱⁱ¹ is preferably a branched alkyl group having 1 to 12 carbon atoms or an alkoxy group in which —O— has been added to the connecting end of the branched alkyl group because this contributes to an enhancement in the stability of a smectic C phase.

Specific examples of the linear alkyl group include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, and an n-dodecyl group.

Specific examples of the branched alkyl group include a 1-methylhexyl group, a 1-ethylhexyl group, a 2-methylhexyl group, a 2-ethylhexyl group, a 1-ethyloctyl group, a 2-ethyloctyl group, a 3-ethyloctyl group, a 1,2-dimethylhexyl group, and a 1,2-diethylhexyl group.

Specific examples of the alkoxyl group having 1 to 12 carbon atoms include groups in which —O— has been added to the connecting end of each of the above-mentioned linear or branched alkyl group having 1 to 12 carbon atoms.

In the liquid crystal composition of the present invention, in order to decrease crystallization temperature, it is preferred that the sterical hindrance of the molecules be enhanced and that the linearity of the mesogenic group be inhibited. From this standpoint, Rⁱ¹ and Rⁱⁱ¹ are each preferably a linear or branched alkyl or alkoxyl group having 1 to 15 carbon atoms; among the —CH₂— moieties of such Rⁱ¹ and Rⁱⁱ¹, a —CH₂— moiety which is distant from the mesogenic group with at least four atoms interposed therebetween is optionally substituted with a 1,4-cyclohexylene group, a 1,4-phenylene group, a 1,4-bicyclo(2,2,2)octylene group, or a dialkylsilylene group.

In the compounds represented by General Formula (i-1), the phase sequence thereof changes as follows on the basis of differences in the molecular structures of A¹, A², A³, Z¹, and Z² of the mesogenic group or in the structures of the terminal groups Rⁱ¹ and Rⁱⁱ¹ for example, (1) an isotropic phase, a nematic phase, and crystal; (2) an isotropic phase, a nematic phase, a smectic A phase, a smectic C phase, and crystal; (3) an isotropic phase, a nematic phase, a smectic C phase, and crystal; and (4) an isotropic phase, a smectic C phase, and crystal. In the case where such compounds that exhibit different phase sequences are used to prepare a composition, compounds that exhibit the phase sequence (1) are preferably used for a nematic liquid crystal composition. In the case where a smectic C liquid crystal composition is prepared, it is preferred that compounds that individually exhibit the phase sequences (1), (2), and (3) be used and that the contents be adjusted so that the phase sequence of an isotropic phase, a nematic phase, a smectic A phase, a smectic C phase, and crystal is produced. In order to enhance the phase transition temperature of the smectic C phase, it is important to narrow the temperature range of a smectic A phase; since use of a compound that exhibits the phase sequence (2) causes the temperature range of the smectic A phase to broaden in many cases, compounds that individually exhibit the phase sequences (3) and (4) are preferably employed. The temperature range of a smectic A phase is preferably adjusted to be within several degrees because it enables an increase in a tilt angle. The compounds used in the present invention each have a high nematic phase transition temperature of not less than 100° C. or a high smectic C phase transition temperature of not less than 70° C. and more tend to have a crystallization temperature of not less than 50° C. when they are used alone; in such a case, a compound having a low crystallization temperature, such as a bicyclic liquid crystal, has been used to decrease crystallization temperature, thereby expanding the temperature range of a nematic phase or smectic C phase. In the present invention, however, liquid crystal compounds which can enhance the steric hindrance of the molecules are used in combination, so that only tricyclic liquid crystal compounds are used to decrease crystallization temperature; thus, the temperature range of the intended liquid crystal phase can be expanded.

The compound represented by General Formula (i-1) is preferably any of compounds represented by General Formula

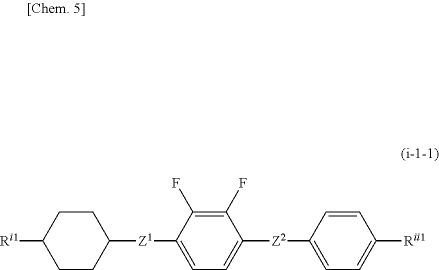

(in the formula, Rⁱ¹, Rⁱⁱ¹, Z¹, and Z² have the same meanings as those in General Formula (i-1), respectively)

In the compound represented by General Formula (i-1-1), Z¹ and Z² are each preferably a single bond or —CH₂CH₂—.

In the liquid crystal composition of the present invention, in order to decrease crystallization temperature, the thermal fluctuations of the molecules are preferably enhanced to inhibit the linearity of the mesogenic group. From this viewpoint, in the compound represented by General Formula (i-1-1), any one of Z¹ and Z² is —CH₂CH₂—, —CF₂O—, or —OCF₂—.

Specifically, the compound represented by General Formula (i-1-1), which can be used in the liquid crystal composition of the present invention, is preferably any of compounds represented by Formulae (i-1-1.1) to (i-1-1.7). Many of these compounds each exhibit the phase sequence of an isotropic phase, a nematic phase, a smectic A phase, a smectic C phase, and crystal and have a smectic C phase transition temperature ranging approximately from 50 to 60° C.; hence, it is preferably used in combination with a compound having a higher smectic C phase transition temperature of not less than 80° C. In particular, combined use thereof with a compound having a difference in the structures of the terminal groups is more preferred because it allows the crystallization temperature to be not more than 0° C.

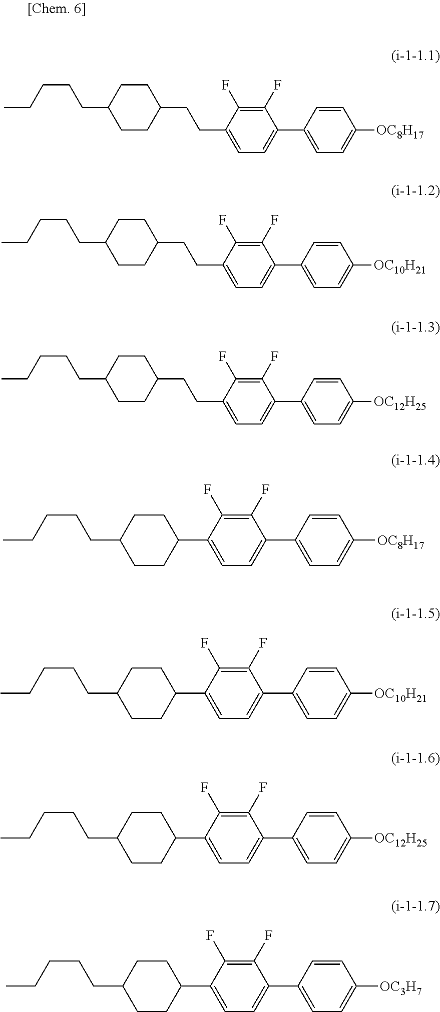

The compound represented by General Formula (i-1) is preferably any of compounds represented by General Formula (i-1-2).

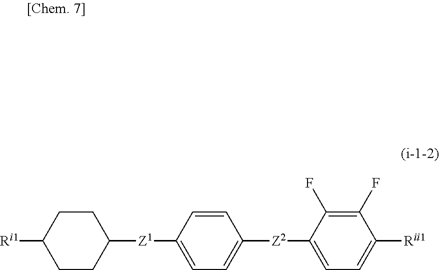

(in the formula, Rⁱ¹, Rⁱⁱ¹, Z¹, and Z² have the same meanings as those in General Formula (i-1), respectively)

In the compound represented by General Formula (i-1-2), preferred Zⁱ¹ and Zⁱ² are the same as those in General Formula (i-1-1), respectively.

In particular, the compound represented by General Formula (i-1-2), which can be used in the liquid crystal composition of the present invention, is preferably any of compounds represented by Formulae (i-1-2.1) to (i-1-2.6).

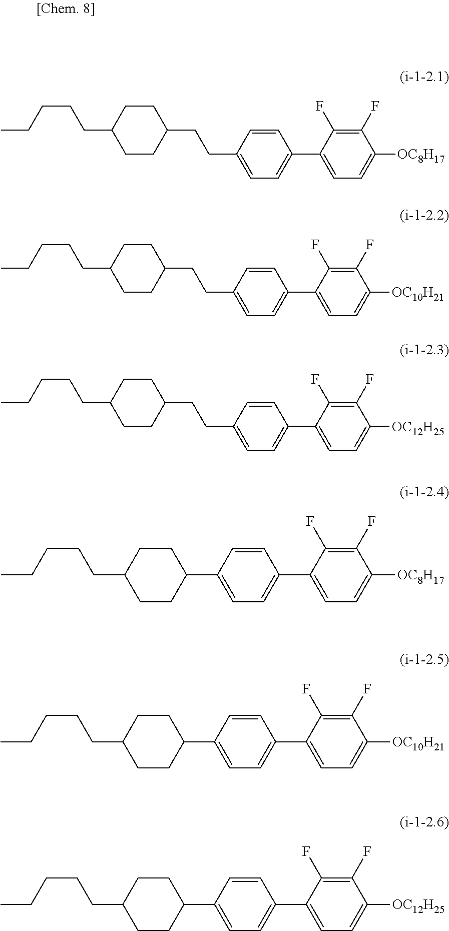

The compound represented by General Formula (i-1) is preferably any of compounds represented by General Formula (i-1-3).

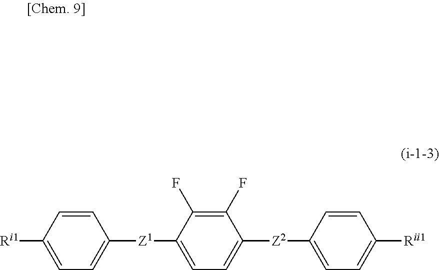

(in the formula, Rⁱ¹, Rⁱⁱ¹, Z¹, and Z² have the same meanings as those in General Formula (i-1-1), respectively)

In the compound represented by General Formula (i-1-3), Zⁱ¹ and Zⁱ² are each preferably a single bond.

The compound represented by General Formula (i-1-3), which can be used in the liquid crystal composition of the present invention, is preferably any of compounds represented by General Formula (i-1-3-1).

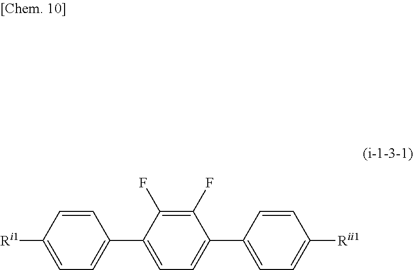

(in the formula, Rⁱ¹ and Rⁱⁱ¹ have the same meanings as those in General Formula (i-1-3), respectively)

Rⁱ¹ and Rⁱⁱ¹ in the compound represented by General Formula (i-1-3-1), which can be used in the liquid crystal composition of the present invention, have an effect on a phase sequence, and the compound has three types of phase sequences of an isotropic phase, a nematic phase, and crystal, an isotropic phase, a nematic phase, a smectic A phase, a smectic C phase, and crystal, and an isotropic phase, a nematic phase, a smectic C phase, and crystal; in addition, phase transition temperature changes as well.

In the case where Rⁱ¹ and Rⁱⁱ¹ are each an alkyl group and have up to five carbon atoms, the compound more tends to exhibit a nematic phase. Such a compound can be used in a nematic liquid crystal composition having a negative dielectric anisotropy in order to expand the temperature range of a nematic phase and to enhance Δn for a decrease in rotational viscosity; hence, this compound is preferred.

Such a compound has a high nematic phase transition temperature of not less than 100° C. and is more likely to increase crystallization temperature; however, using this compound in combination with a compound represented by General Formula (i-1-3-1) but having a difference in the structures of the terminal groups in a nematic composition is preferred because it enables a reduction in the increase of crystallization temperature.

In the case where any one of Rⁱ¹ and Rⁱⁱ¹ is an alkoxyl group and has at least four carbon atoms, the compound more tends to exhibit a smectic C phase and is therefore useful in a smectic liquid crystal composition. In the case where any one of Rⁱ¹ and Rⁱⁱ¹ is an alkoxyl group having seven or more carbon atoms, the smectic C phase transition temperature is not less than 90° C., and thus the smectic C phase becomes highly stable; accordingly, such a compound is suitably employed to increase the smectic C phase transition temperature of a composition. In particular, when any one of Rⁱ¹ and Rⁱⁱ¹ is an alkoxyl group having eight carbon atoms, the compound has the phase sequence of an isotropic phase, a nematic phase, a smectic C phase, and crystal and has a wide temperature range of the smectic C phase by itself in which an SmC phase is in a temperature range from 48° C. to 95° C.; hence, this compound is used in combination with a compound represented by General Formula (i-1-3-1) but having a difference in the structures of the terminal groups, so that crystallization temperature is more likely to be decreased to be 0° C. or lower. Thus, such a compound is preferred. Moreover, this compound is helpful in terms of a phase sequence in a smectic composition and an enhancement in the upper limit of the temperature of a smectic C phase.

In the case where any one of Rⁱ¹ and Rⁱⁱ¹ is a branched alkoxyl group, it enhances the steric hindrance of the molecules and increases the tendency to inhibit the linearity of the mesogenic group, so that the crystallization temperature of a smectic composition is decreased with the result that the lower limit of the temperature of a smectic C phase is decreased; hence, this compound is preferred. Using a compound represented by General Formula (i-1-3-1) but having a difference in the structures of the terminal groups in combination is more preferred because it enables a decrease in crystallization temperature and results in the expansion of the temperature range of a smectic C phase.

The compound represented by General Formula (i-1-3-1) is preferably any of compounds represented by General Formula (i-1-3-1.1).

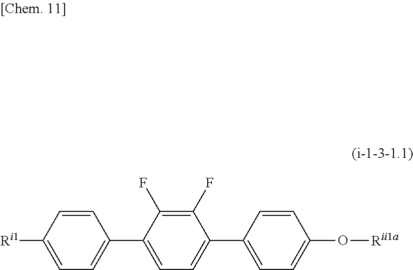

(in the formula, Rⁱ¹ has the same meaning as that in General Formula (i-1-3-1), and R^{ii1a} represents a linear or branched alkyl group having 1 to 18 carbon atoms)

In particular, the compound is preferably any of compounds represented by Formulae (i-1-3-1.1.1) to (i-1-3-1.1.6).

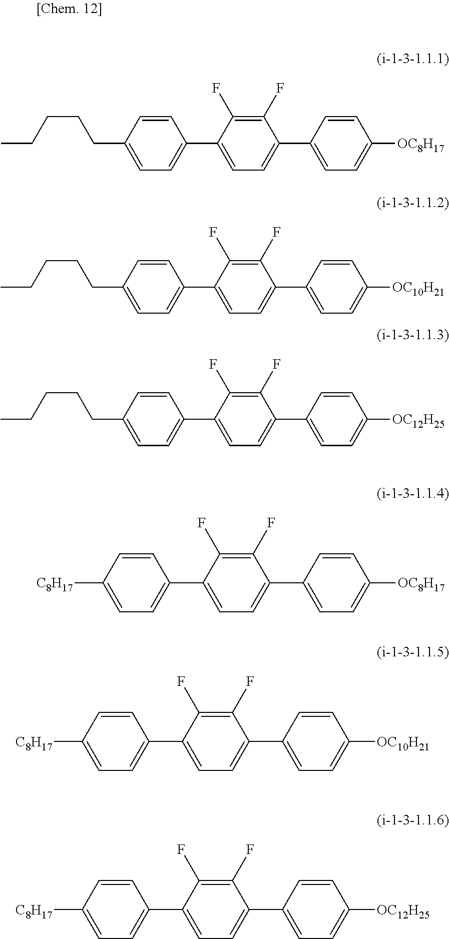

The compound represented by General Formula (i-1-3-1.1) is preferably any of compounds represented by General Formula (i-1-3-1.2).

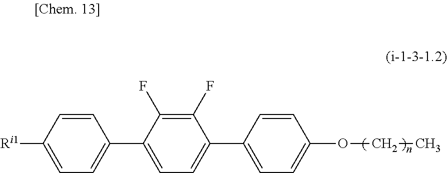

(in the formula, Rⁱ¹ has the same meaning as that in General Formula (i-1-3), n represents an integer from 3 to 15, and —O—(CH₂)n-CH₃ has a branched chain)

In particular, the compound is preferably any of compounds represented by Formulae (i-1-3-1.2.1) and (i-1-3-1.2.2).

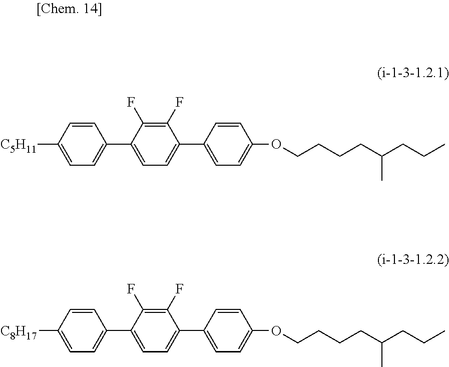

The compound represented by General Formula (i-1) is preferably any of compounds represented by General Formula (i-1-4).

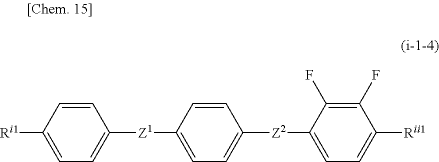

(in the formula, Rⁱ¹, Rⁱⁱ¹, Z¹, and Z² have the same meanings as those in General Formula (i-1-3), respectively)

In the compound represented by General Formula (i-1-4), Z¹ and Z² are each preferably a single bond or —CH₂O—.

The compound represented by General Formula (i-1-4), which can be used in the liquid crystal composition of the present invention, is preferably any of compounds represented by General Formula (i-1-4-1).

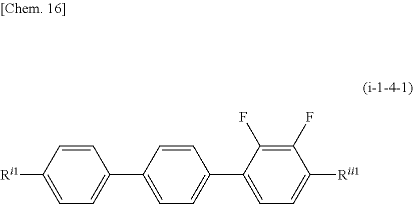

(in the formula, Rⁱ¹ and R^{i1′} have the same meanings as those in General Formula (i-1-4), respectively)

The compound represented by General Formula (i-1-4-1), which can be used in the liquid crystal composition of the present invention, has the phase sequence of an isotropic phase, a nematic phase, and crystal, an isotropic phase, a nematic phase, a smectic C phase, and crystal, or an isotropic phase, a nematic phase, a smectic A phase, a smectic C phase, and crystal on the basis of a change in the number of the carbon atoms of each of Rⁱ¹ and Rⁱⁱ¹ or in the type of a substituent; and the phase transition temperature and other properties change as well.

In the case where Rⁱ¹ and Rⁱⁱ¹ are each an alkyl group having not more than four carbon atoms, the compound more tends to exhibit a nematic phase and has a high nematic phase transition temperature of approximately 140° C. Addition of such a compound to a nematic liquid crystal composition having a negative dielectric anisotropy is effective to enhance a nematic phase transition temperature; however, this compound has a high crystallization temperature and therefore can be added by itself to a composition in a limited amount. Using such a compound in combination with another compound having a different terminal group is preferred because it contributes to a decrease in crystallization temperature.

Compounds in which any one of Rⁱ¹ and Rⁱⁱ¹ is an alkoxyl group are more likely to exhibit a smectic phase even when they each have two carbon atoms, and a smectic C phase is highly stable. Many of such compounds have a smectic C phase transition temperature of greater than 130° C. and are therefore suitable for enhancing smectic C phase transition temperature. In this case, since phase transition is more likely to be in the phase sequence of an isotropic phase, a nematic phase, a smectic A phase, a smectic C phase, and crystal, the temperature range of a smectic A phase should be considered not to be large in the compositional design of a smectic composition.

For example, in the case of an alkoxyl group having eight carbon atoms, phase transition is from a nematic phase (166° C.) to a smectic C phase (155° C.) through a smectic A phase (165° C.), and the compound itself has a wide temperature range of a smectic C phase in which an SmC phase is from 89° C. to 155° C. but has a high crystallization temperature (89° C.); hence, such a compound tends to enhance crystallization temperature in a smectic composition.

Combined use thereof with a compound that exhibits a smectic C phase and that has a difference in the structures of terminal groups, however, enables a decrease in the crystallization temperature and is therefore preferred. In the case where any one of Rⁱ¹ and Rⁱⁱ¹ is a branched alkoxyl group, it enhances the steric hindrance of the molecules and increases the tendency to inhibit the linearity of the mesogenic group, so that the crystallization temperature of a smectic composition is likely to be decreased. Hence, using such a compound in combination with a compound that exhibits a smectic C phase and that has a difference in the structures of terminal groups is more preferred because it enables a decrease in crystallization temperature.

The compound represented by General Formula (i-1-4-1) is preferably any of compounds represented by General Formula (i-1-4-1.1).

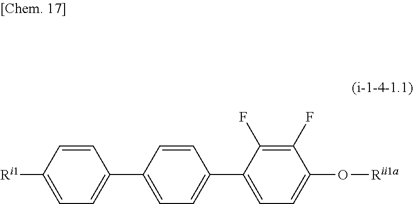

(in the formula, Rⁱ¹ has the same meaning as that in General Formula (i-1-4), and R^{ii1a} represents a linear or branched alkyl group having 1 to 18 carbon atoms)

In particular, the compound is preferably any of compounds represented by Formulae (i-1-4-1.1.1) to (i-1-4-1.1.3).

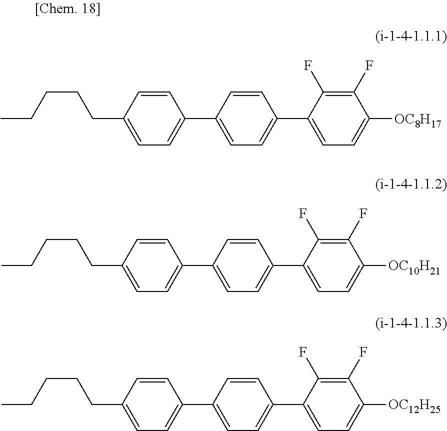

The compound represented by General Formula (i-1-4-1.1) is preferably any of compounds represented by General Formula (i-1-4-1.2).

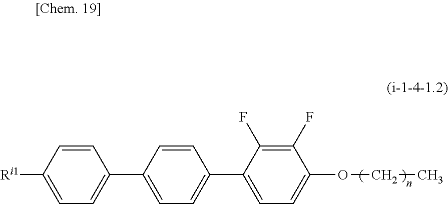

(in the formula, Rⁱ¹ has the same meaning as that in General Formula (i-1-4), n represents an integer from 3 to 15, and —O— (CH₂)n-CH₃ has a branched chain)

In particular, the compound is preferably any of compounds represented by Formulae (i-1-4-1.2.1) and (i-1-4-1.2.2).

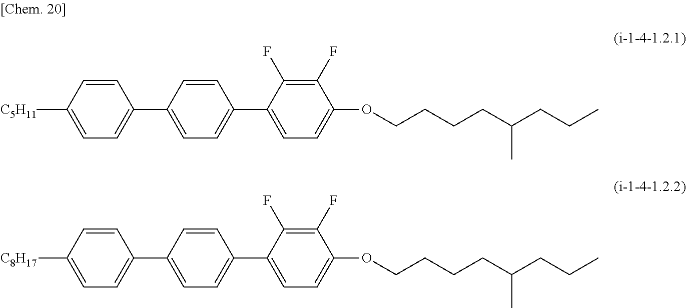

The compound represented by General Formula (i-1-4), which can be used in the liquid crystal composition of the present invention, is preferably any of compounds represented by General Formula (i-1-4-2).

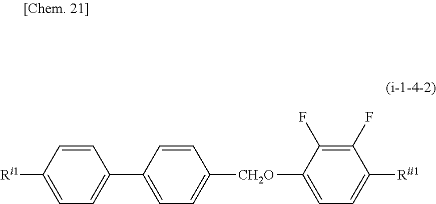

(in the formula, Rⁱ¹ and R=ⁱ¹ have the same meanings as those in General Formula (i-1-4), respectively)

In the case where the compound represented by General Formula (i-1-4-2), which can be used in the liquid crystal composition of the present invention, has an alkyl group having 6 to 9 carbon atoms, the phase sequence thereof is more likely to have transition from a nematic phase to a smectic C phase, and the compound is therefore preferably used in a smectic liquid crystal composition. If the compound has an alkoxyl group, the stability of a smectic C phase is enhanced; hence, such a compound is more preferred. In particular, a compound in which Rⁱ¹ and Rⁱⁱ¹ each have eight carbon atoms exhibits only a smectic C phase and is therefore especially preferred.

Specifically, the compound is preferably any of compounds represented by Formulae (i-1-4-2.1) to (i-1-4-2.4).

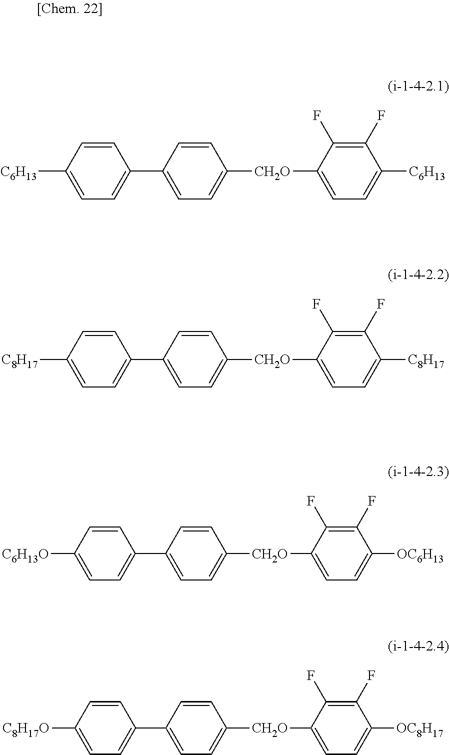

The compound represented by General Formula (i-1) is preferably any of compounds represented by General Formula (i-1-5).

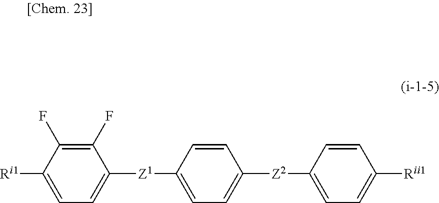

(in the formula, Rⁱ¹, Rⁱⁱ¹, Z¹, and Z² have the same meanings as those in General Formula (i-1-1), respectively)

In the compound represented by General Formula (i-1-5), Z¹ and Z² are each preferably a single bond.

The compound represented by General Formula (i-1-5), which can be used in the liquid crystal composition of the present invention, is preferably any of compounds represented by General Formula (i-1-5-1).

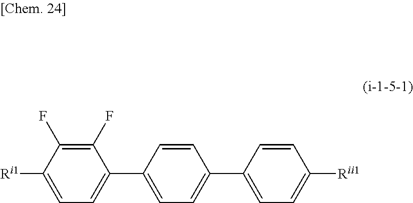

In particular, the compound represented by General Formula (i-1-5-1), which can be used in the liquid crystal composition of the present invention, is preferably any of compounds represented by Formulae (i-1-5-1.1) to (i-1-5-1.4).

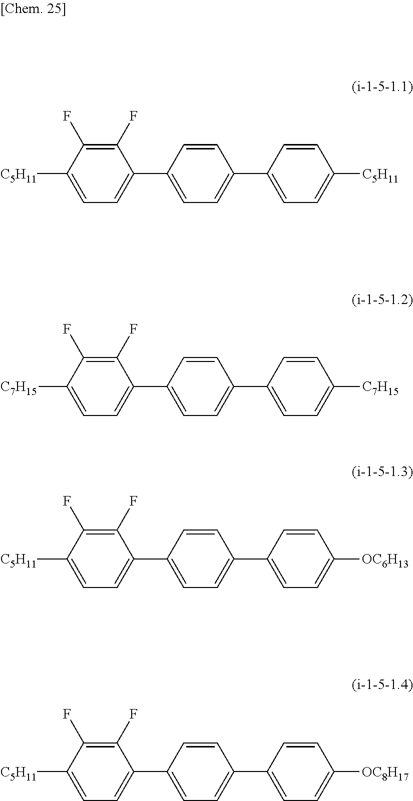

The compound represented by General Formula (i) contains three or more rings, and preferably three or four rings as described above. A preferred tetracyclic liquid crystal compound is any of compounds represented by General Formula (i-2).

[Chem. 26]

Rⁱ¹-A¹-Z¹-A²-Z²-A³-Rⁱⁱ² (1-2)

(in the formula, Rⁱ¹, A¹, A², A³, Z¹, and Z² have the same meanings as those in General Formula (i), respectively; Rⁱⁱ² represents a linear or branched alkyl group having 1 to 20 carbon atoms; and among the —CH₂— moieties of the alkyl group, a —CH₂— moiety which is distant from the mesogenic group with at least four atoms interposed therebetween is substituted with a 1,4-cyclohexylene group, a 1,4-phenylene group, a 1,4-bicyclo(2,2,2)octylene group, or a dialkylsilylene group)

Rⁱⁱ² that is a terminal group is preferably a linear or branched alkyl group or a linear or branched alkyl group substituted with a cyclic group.

The compound represented by General Formula (i-2) is preferably any of compounds represented by General Formula (i-2-1).

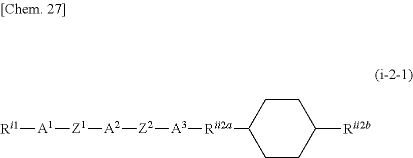

(in the formula, R^{ii2a} represents a linear or branched alkyl group having 1 to 5 carbon atoms; one —CH₂— moiety or at least two —CH₂— moieties not adjoining each other in the alkyl group are each independently optionally substituted with —CH═CH—, —C≡C—, —O—, —CO—, —COO—, or —OCO—; R^{ii2b} represents a hydrogen atom or a linear or branched alkyl group having 1 to 5 carbon atoms; one —CH₂— moiety or at least two —CH₂— moieties not adjoining each other in the alkyl group are each independently optionally substituted with —CH═CH—, —C≡C—, —O—, —CO—, —COO—, or —OCO—; and Rⁱ¹, A¹, A², A³, Z¹, and Z² have the same meanings as those in General Formula (i-2), respectively)

In General Formula (i-2-1), R^{ii2a} and R^{ii2b} are each preferably a linear or branched alkyl group having 1 to 5 carbon atoms or an alkoxy group having 1 to 5 carbon atoms.

Specific examples of the linear alkyl group include a methyl group, an ethyl group, an n-propyl group, an n-butyl group, and an n-pentyl group.

Specific examples of the branched alkyl group include an isopropyl group, an isobutyl group, a sec-butyl group, a tert-butyl group, an isopentyl group, a neopentyl group, and a tert-pentyl group.

Examples of the alkoxy group having 1 to 5 carbon atoms include groups in which —O— has been added to the connecting end of each of the above-mentioned linear or branched alkyl group 1 to 5 carbon atoms.

In the liquid crystal composition of the present invention, in order to decrease crystallization temperature, it is preferred that the sterical hindrance of the molecules be enhanced and that the linearity of the mesogenic group be inhibited. From this standpoint, in the compound represented by General Formula (i-2-1), a terminal group has a cyclohexylene group.

The compound represented by General Formula (i-2-1) is preferably any of compounds represented by General Formula (i-2-1-1).

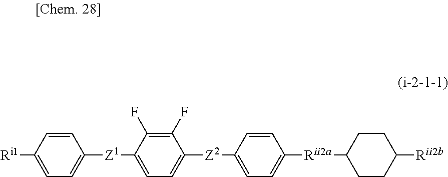

(in the formula, Rⁱ¹, Z¹, Z², R^{ii2a}, and R^{ii2b} have the same meanings as those in General Formula (i-2-1), respectively)

In the compound represented by General Formula (i-2-1-1), Z¹, Z², and R^{ii2a} are each preferably a single bond or —O—(CH₂)n-. n represents an integer from 1 to 10, and preferably from 1 to 6.

In the compound represented by General Formula (i-2-1-1), R^{ii2b} is preferably a linear or branched alkyl group having 1 to 5 carbon atoms or a hydrogen atom.

In the liquid crystal composition of the present invention, in order to decrease crystallization temperature, the thermal fluctuations of the molecules are preferably enhanced to inhibit the linearity of the mesogenic group. From this viewpoint, in the compound represented by General Formula (i-2-1-1), Zⁱ³ is preferably —O—(CH₂)n-, so that a liquid crystal composition having a low crystallization temperature can be produced.

The compound represented by General Formula (i-2-1-1), which can be used in the liquid crystal composition of the present invention, is preferably any of compounds represented by General Formula (i-2-1-1.1).

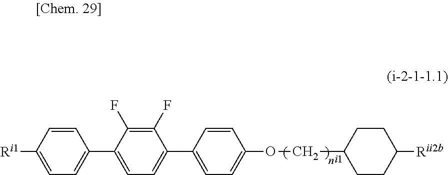

(in the formula, R^{ii2b} and Rⁱ¹ have the same meanings as those in General Formula (i-2-1-1), respectively, and nⁱ¹ is an integer from 1 to 6)

In General Formula (i-2-1-1.1), the terminal groups are Rⁱ¹ and part of the structure which is on the right side relative to a benzene ring (from the oxygen atom to R^{ii2b}).

In particular, the compound represented by General Formula (i-2-1-1.1), which can be used in the liquid crystal composition of the present invention, is preferably any of compounds represented by Formulae (i-2-1-1.1.1) to (i-2-1-1.1.5).

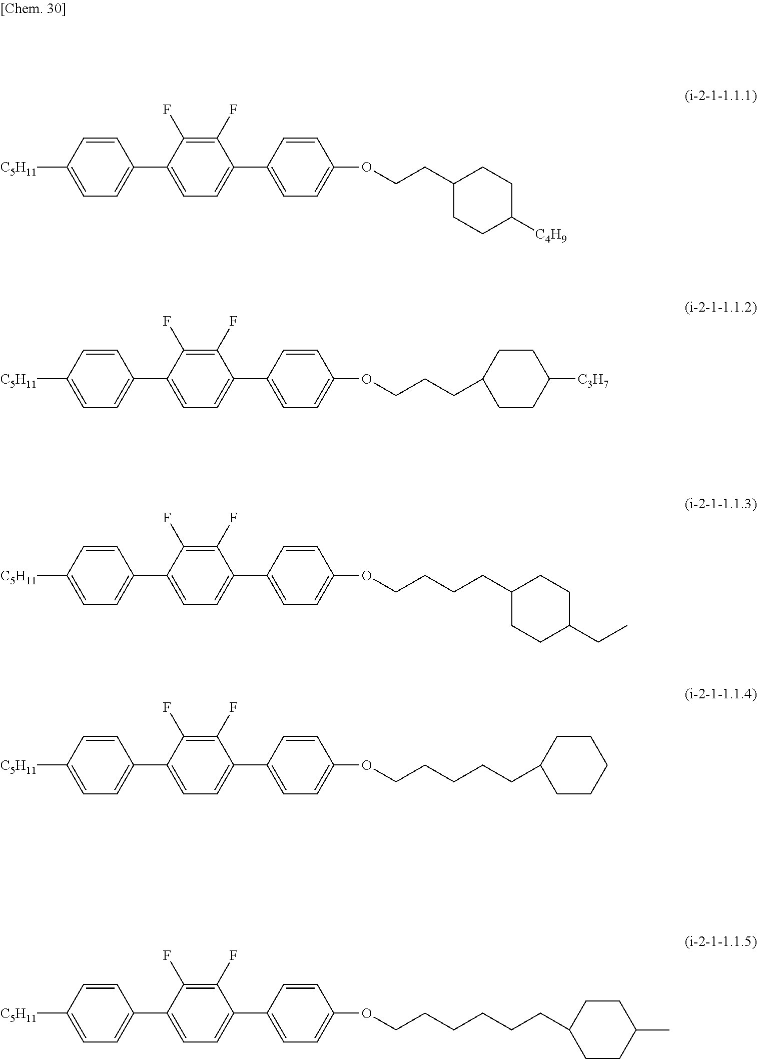

The compound represented by General Formula (i-2-1) is preferably any of compounds represented by General Formula (i-2-1-2).

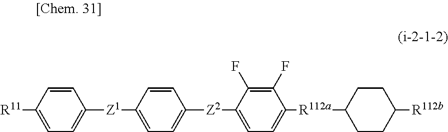

(in the formula, R^{ii2a}, R^{ii2b}, Rⁱ¹, Z¹, and Z² have the same meanings as those in General Formula (i-2-1), respectively)

In General Formula (i-2-1-2), the terminal groups are Rⁱ¹ and part of the structure which is on the right side relative to a benzene ring (from R^{ii2a} to R^{ii2b})

In the compound represented by General Formula (i-2-1-2), Z¹, Z², and R^{ii2a} are each preferably a single bond or —O—(CH₂)n-. n represents an integer from 1 to 10, and preferably from 1 to 6.

In the liquid crystal composition of the present invention, in order to decrease crystallization temperature, the thermal fluctuations of the molecules are preferably enhanced to inhibit the linearity of the mesogenic group. From this viewpoint, in the compound represented by General Formula (i-2-1-2), R^{ii2a} is preferably —O—(CH₂)n-, so that a liquid crystal composition having a low crystallization temperature can be produced.

The compound represented by General Formula (i-2-1-2), which can be used in the liquid crystal composition of the present invention, is preferably any of compounds represented by General Formula (i-2-1-2-1).

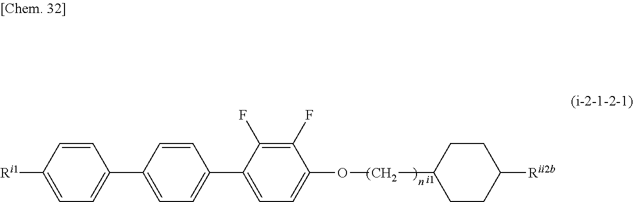

(in the formula, R^{ii1b} and Rⁱ¹ have the same meanings as those in General Formula (i-2-1-2), respectively, and nⁱ¹ is an integer from 1 to 6)

In General Formula (i-2-1-2-1), the terminal groups are Rⁱ¹ and part of the structure which is on the right side relative to a benzene ring (from the oxygen atom to Riib).

In particular, the compound represented by General Formula (i-2-1-2-1), which can be used in the liquid crystal composition of the present invention, is preferably any of compounds represented by Formulae (i-2-1-2-1.1) to (i-2-1-2-1.3).

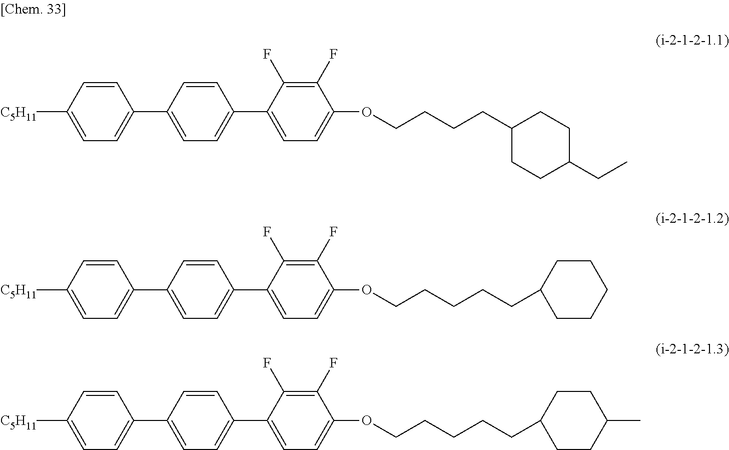

The compound represented by General Formula (i-2-1) is preferably any of compounds represented by General Formula

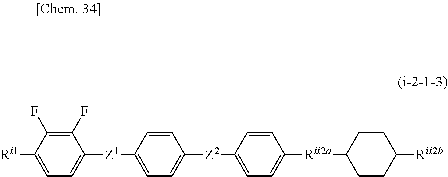

(in the formula, R^{ii2a}, R^{ii2b}, Rⁱ¹, Z¹, and Z² have the same meanings as those in General Formula (i-2-1-1), respectively)

In General Formula (i-2-1-3), the terminal groups are Rⁱ¹ and part of the structure which is on the right side relative to a benzene ring (from R^{ii2a} to R^{ii2b}).

In the compound represented by General Formula (i-2-1-3), Z¹, Z², and R^{ii2a} are each preferably a single bond or —O—(CH₂)n-. n represents an integer from 1 to 10, and preferably from 1 to 6.

In the liquid crystal composition of the present invention, in order to decrease crystallization temperature, the thermal fluctuations of the molecules are preferably enhanced to inhibit the linearity of the mesogenic group. From this viewpoint, in the compound represented by General Formula (i-2-1-3), R^{ii2a} is preferably —O—(CH₂)n-, so that a liquid crystal composition having a low crystallization temperature can be produced.

The compound represented by General Formula (i-2-1-3), which can be used in the liquid crystal composition of the present invention, is preferably any of compounds represented by General Formula (i-2-1-3-1).

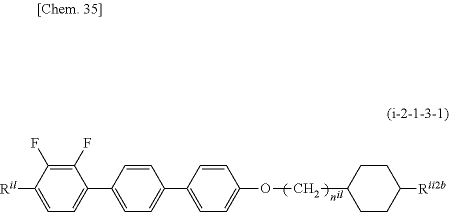

(in the formula, R^{ii1b}, Rⁱ¹, and nⁱ¹ have the same meanings as those in General Formula (i-2-1-2-1), respectively)

In General Formula (i-2-1-3-1), the terminal groups are Rⁱ¹ and part of the structure which is on the right side relative to a benzene ring (from the oxygen atom to R^{ii2b}).

In particular, the compound represented by General Formula (i-2-1-3-1), which can be used in the liquid crystal composition of the present invention, is preferably any of compounds represented by Formulae (i-2-1-3-1.1) to (i-2-1-3-1.4).

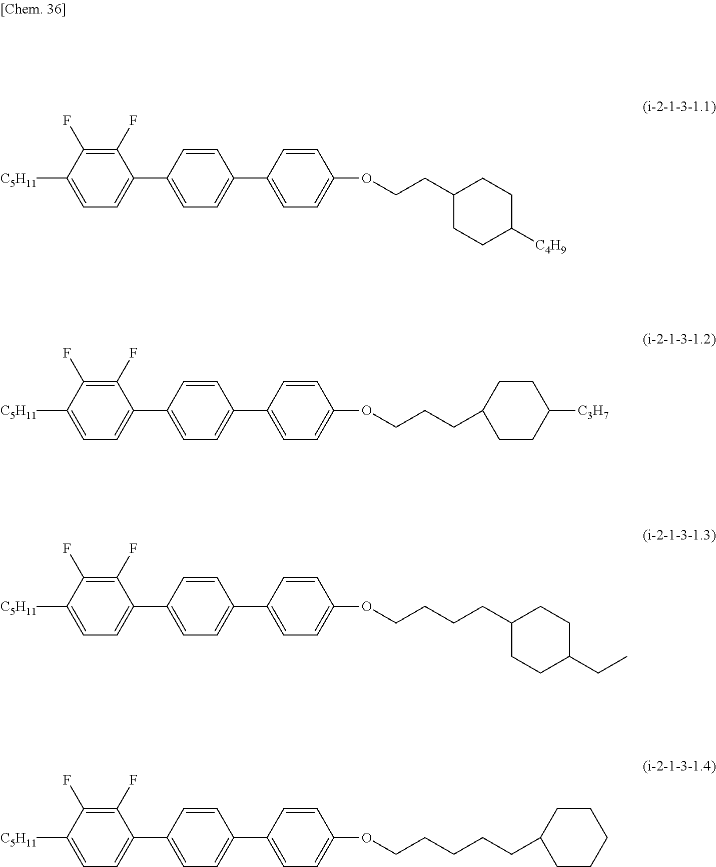

The compound represented by General Formula (i-2-1) is preferably any of compounds represented by General Formula (i-2-1-4).

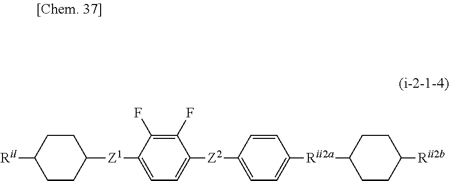

(in the formula, R^{ii2a}, R^{ii2b}, Rⁱ¹, Z¹, and Z² have the same meanings as those in General Formula (i-2-1-1), respectively)

In General Formula (i-2-1-4), the terminal groups are Rⁱ¹ and part of the structure which is on the right side relative to a benzene ring (from R^{ii2a} to R^{ii2b}).

In the compound represented by General Formula (i-2-1-4), Z¹, Z², and R^{ii2a} are each preferably a single bond or —O—(CH₂)n-. n represents an integer from 1 to 10, and preferably from 1 to 6.

In the liquid crystal composition of the present invention, in order to decrease crystallization temperature, the thermal fluctuations of the molecules are preferably enhanced to inhibit the linearity of the mesogenic group.

From this viewpoint, in the compound represented by General Formula (i-2-1-4), R^{ii2a} is preferably —O—(CH₂)n-, so that a liquid crystal composition having a low crystallization temperature can be produced.

The compound represented by General Formula (i-2-1-4), which can be used in the liquid crystal composition of the present invention, is preferably any of compounds represented by General Formula (i-2-1-4-1).

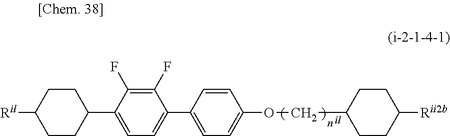

(in the formula, R^{ii2b}, Rⁱ¹, and nⁱ¹ have the same meanings as those in General Formula (i-2-1-3-1), respectively)

In General Formula (i-2-1-4-1), the terminal groups are Rⁱ¹ and part of the structure which is on the right side relative to a benzene ring (from the oxygen atom to R^{ii2b})

In particular, the compound represented by General Formula (i-2-1-4-1), which can be used in the liquid crystal composition of the present invention, is preferably any of compounds represented by Formulae (i-2-1-4-1.1) to (i-2-1-4-1.5).

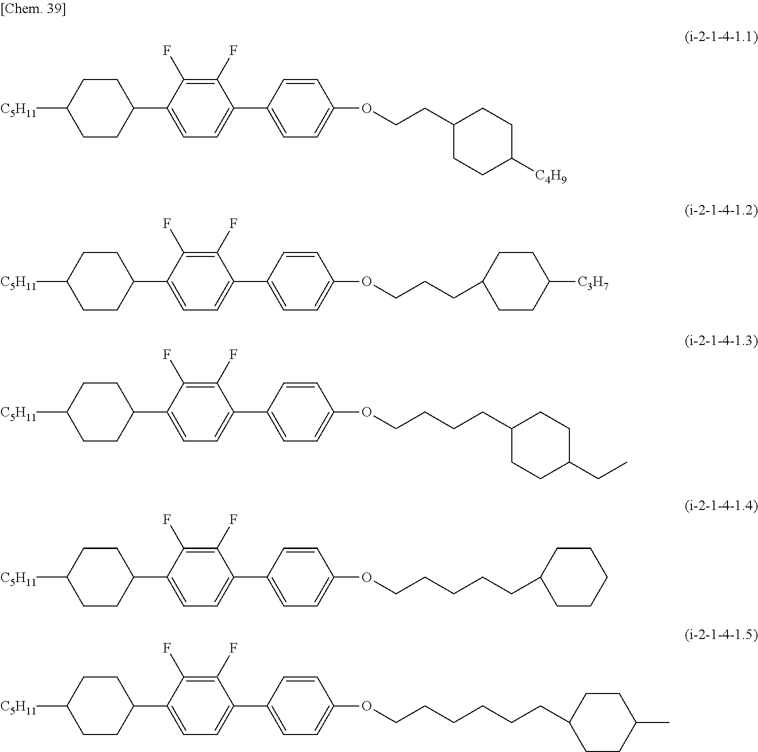

The liquid crystal composition of the present invention contains at least two of the above-mentioned liquid crystal compounds. Hence, although the liquid crystal composition provided according to the present invention is free from a liquid crystal compound having a pyrimidine skeleton, the crystallization temperature thereof is maintained to be at a low level, and the upper limit of the temperature of a smectic C* phase is high, in other words, the temperature range of the smectic C* phase is wide.

In the liquid crystal composition of the present invention, the mesogenic group contained in each of the above-mentioned liquid crystal compounds is preferably at least one selected from the group consisting of a 2′,3′-difluoroterphenyl group, a 2,3-difluoroterphenyl group, and a 2″,3″-difluoroterphenyl group.

Examples of a liquid crystal compound having a 2′,3′-difluoroterphenyl group include compounds represented by General Formula (i-1-3) and compounds represented by General Formula (i-2-1-1).

Examples of a liquid crystal compound having a 2,3-difluoroterphenyl group include compounds represented by General Formula (i-1-4) and compounds represented by General Formula (i-2-1-2).

Examples of a liquid crystal compound having a 2″,3″-difluoroterphenyl group include compounds represented by General Formula (i-1-5) and compounds represented by General Formula (i-2-1-3).

In the liquid crystal composition of the present invention, at least two compounds represented by different general formulae may be selected from these groups of compounds, or at least two compounds represented by the same general formula but having a difference in at least one of the two terminal groups may be selected. In particular, the liquid crystal composition of the present invention preferably contains at least one pair of liquid crystal compounds having a difference in at least one of the two terminal groups thereof. Using liquid crystal compounds having different terminal groups in combination enables a reduction in a melting point and production of a liquid crystal composition having a wide temperature range of a smectic C* phase.

A preferred combination of liquid crystal compounds in the liquid crystal composition of the present invention is, for instance, a combination of a liquid crystal compound having a 2′,3′-difluoroterphenyl group as the mesogenic group and a liquid crystal compound having a 2,3-difluoroterphenyl group as the mesogenic group; in this combination, the liquid crystal compound having a 2′,3′-difluoroterphenyl group and the liquid crystal compound having a 2,3-difluoroterphenyl group are different from each other in each of the two terminals thereof or in one of the two terminals thereof.

Examples of such a combination include a combination of the compound represented by Formula (i-1-4-1.2.1) and the compound represented by Formula (i-1-3-1.1.1) and a combination of the compound represented by Formula (i-1-4-1.2.2) and the compound represented by Formula (i-1-2-1.7).

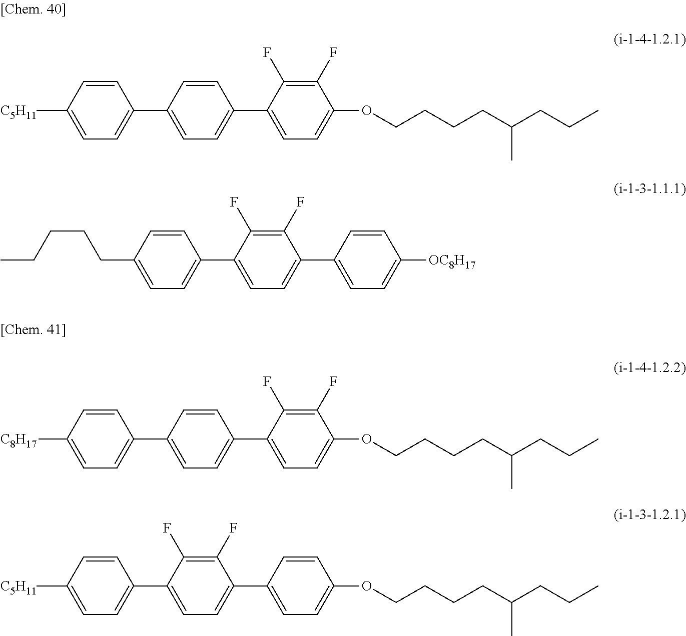

Another preferred combination of liquid crystal compounds in the liquid crystal composition of the present invention is, for example, a combination of at least two liquid crystal compounds each having a 2′,3′-difluoroterphenyl group as the mesogenic group. Examples of such a combination include a combination of the compound represented by Formula (i-1-3-1.1.1) and the compound represented by Formula (i-2-1-1.1.3), a combination of the compound represented by Formula (i-1-3-1.2.1) and the compound represented by Formula (i-2-1-1.1.3), and a combination of the compound represented by Formula (i-1-3-1.2.1) and the compound represented by Formula (i-1-3-1.1.1).

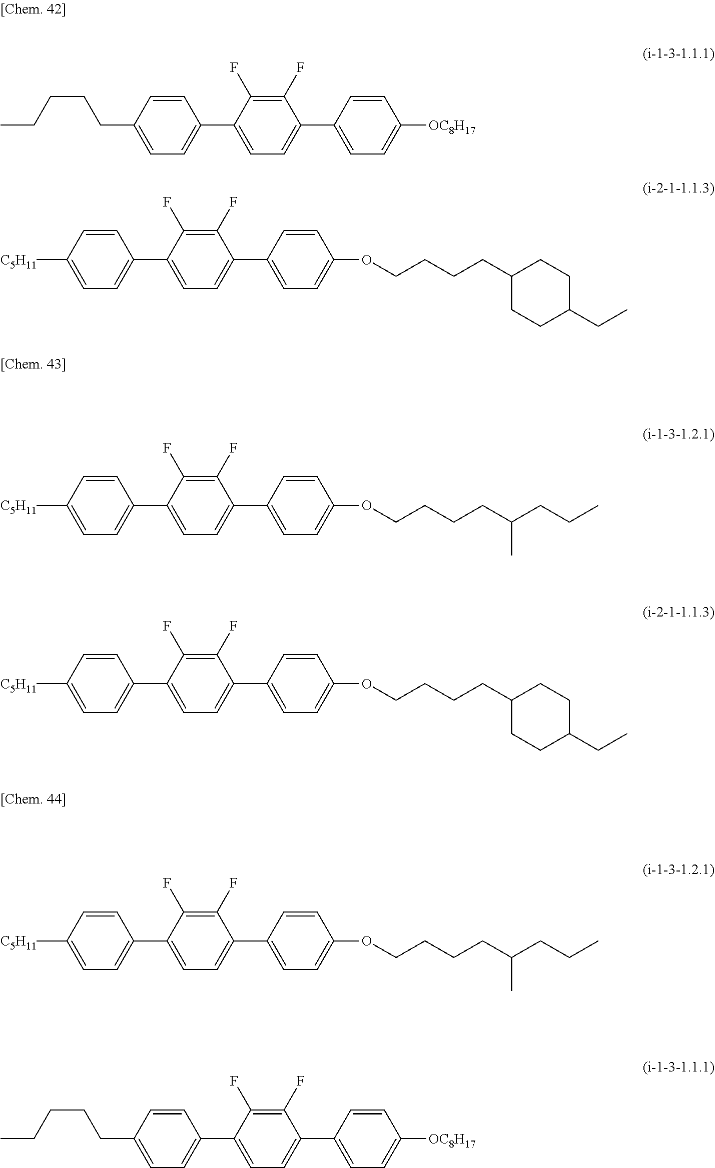

As in the above-mentioned preferred combination of liquid crystal compounds, at least one of the terminal groups contained in a liquid crystal compound used in the liquid crystal composition of the present invention is preferably an alkyl group having 4 to 15 carbon atoms or an alkoxyl group having 4 to 15 carbon atoms, and more preferably an alkyl group having 7 to 15 carbon atoms or an alkoxyl group having 7 to 15 carbon atoms.

In the liquid crystal composition of the present invention, the relative amount of the compound represented by General Formula (i) to the total mass of the liquid crystal composition of the present invention can be optionally adjusted in view of the phase transition temperature, the phase sequence, and the crystallization temperature; the amount is preferably in the range of 20 to 70 mass % in the case where four or more components are used in the composition, 60 to 100 mass % in the case where three components are used, and 90 to 100 mass % in the case where two components are used.

The liquid crystal composition of the present invention preferably further contains at least one compound containing an optically active substance.

The compound containing an optically active substance may be either a compound having an asymmetric atom, a compound having axial chirality, a compound having planar chirality, or an atropisomer and may optionally have a polymerizable group.

In the compound having an asymmetric atom, if the asymmetric atom is an asymmetric carbon atom, the asymmetric atom is less likely to cause stereoinversion and is therefore preferred. A hetero atom may be the asymmetric atom. The asymmetric atom may be introduced to a part of a chain structure or may be introduced to a part of a cyclic structure.

In particular, preferred examples of such a compound include compounds represented by General Formula (ii).

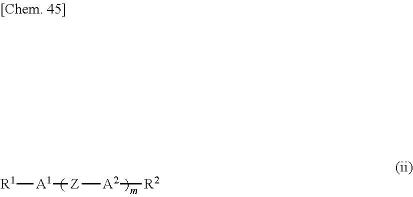

(in Formula (ii), R¹ and R² each independently represent a linear or branched alkyl group having 1 to 30 carbon atoms, a hydrogen atom, or a fluorine atom; in the alkyl group, one —CH₂— group or two or more —CH₂— groups not adjoining each other are each optionally substituted with —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—; in the alkyl group, at least one hydrogen atom is optionally substituted with a fluorine atom or a bromine atom; the alkyl group optionally has a polymerizable group; the alkyl group optionally contains a fused or spiro ring system; the alkyl group optionally contains one or more aromatic or aliphatic rings which optionally contain one or more hetero atoms and which are each optionally substituted with an alkyl group, an alkoxy group, or a halogen atom; any one or both of R¹ and R² are groups having asymmetric atoms;

Z each independently represents —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond;

R^{a} of —CO—N(R^{a})— or —N(R^{a})—CO— represents a hydrogen atom or a linear or branched alkyl group having 1 to 4 carbon atoms;
A¹ and A² each independently represent a cyclic group selected from a phenylene group, a cyclohexylene group, a dioxolanediyl group, a cyclohexenylene group, a bicyclo[2.2.2]octylene group, a piperidinediyl group, a naphthalenediyl group, a decahydronaphthalenediyl group, a tetrahydronaphthalenediyl group, and an indanediyl group; in the phenylene group, the naphthalenediyl group, the tetrahydronaphthalenediyl group, and the indanediyl group, at least one —CH═ group in each ring is optionally substituted with a nitrogen atom; in the cyclohexylene group, the dioxolanediyl group, the cyclohexenylene group, the bicyclo[2.2.2]octylene group, the piperidinediyl group, the decahydronaphthalenediyl group, the tetrahydronaphthalenediyl group, and the indanediyl group, one —CH₂— group or two —CH₂— groups not adjoining each other in each ring are optionally substituted with —O— and/or —S—;
at least one hydrogen atom of each cyclic group is optionally substituted with a fluorine atom, a bromine atom, an NO₂ group, or an alkyl, alkoxy, alkylcarbonyl, or alkoxycarbonyl group which has 1 to 7 carbon atoms and of which one or more hydrogen atoms are each optionally substituted with a fluorine atom; and
m is 1, 2, 3, 4, or 5)

The compound represented by General Formula (ii) is preferably a dichiral compound in which both R¹ and R² are chiral groups. Specific examples of the dichiral compound include compounds represented by General Formulae (ii-a1) to (ii-a11).

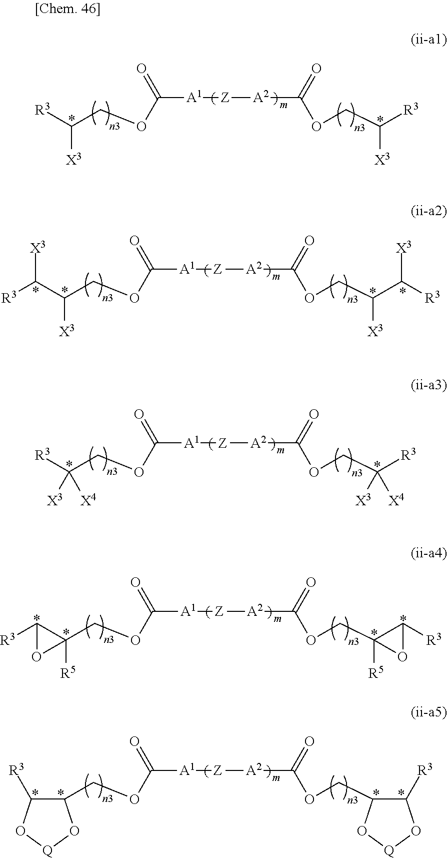

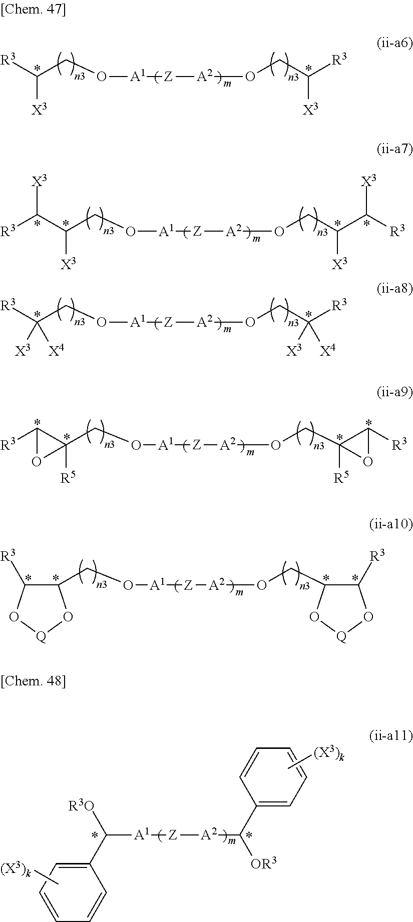

In General Formulae (ii-a1) to (ii-a11), R³ each independently represents a linear or branched alkyl group having 1 to 10 carbon atoms; in the alkyl group, one —CH₂— group or two or more —CH₂— groups not adjoining each other are optionally substituted with —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—; in the alkyl group, at least one hydrogen atom is optionally substituted with a fluorine atom or a bromine atom; and the alkyl group optionally has a polymerizable group. Examples of the polymerizable group include a vinyl group, an allyl group, and a (meth)acryloyl group.

X³ and X⁴ are each preferably a fluorine atom, a phenyl group (of which at least any one hydrogen atom is optionally substituted with a fluorine atom, a methyl group, a methoxy group, —CF₃, or —OCF₃), a methyl group, a methoxy group, —CF₃, or —OCF₃. In each of General Formulae (ii-a3) and (ii-a8), in order that the atoms at the positions indicated by the symbol * are asymmetric, the groups represented by X⁴ and X³ are different from each other.

n₃ is an integer from 0 to 20.

R⁵ in each of General Formulae (ii-a4) and (ii-a9) is preferably a hydrogen atom or a methyl group.

Q in each of General Formulae (ii-a5) and (ii-a10) is a divalent hydrocarbon group such as a methylene group, an isopropylidene group, or a cyclohexylidene group.

k in General Formula (ii-a11) is an integer from 0 to 5.

In a preferred example, R³ is a linear or branched alkyl group having 4 to 8 carbon atoms, such as C₄H₉, C₆H₁₃, or C₈H₁₇. X³ is preferably CH₃.

The part of the structure -A¹-(Z-A²)ₘ- in General Formulae (ii) and (ii-a1) to (ii-a11) is more preferably represented by the following formula.

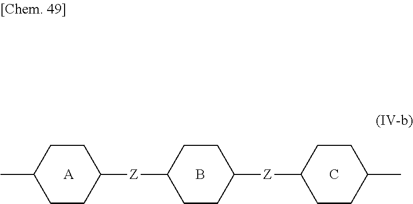

(in the formula, rings A, B, and C are each independently a phenylene group, a cyclohexylene group, or a naphthalenediyl group; in such groups, at least any one hydrogen atom of a benzene ring is optionally substituted with a fluorine atom, a methyl group, a methoxy group, —CF₃, or —OCF₃; and at least any one carbon atom of a benzene ring is optionally substituted with a nitrogen atom; and the definition of Z is the same as that in Formula (ii)) The part of the structure -A¹-(Z-A²)ₘ- is more preferably represented by any of the following formulae.

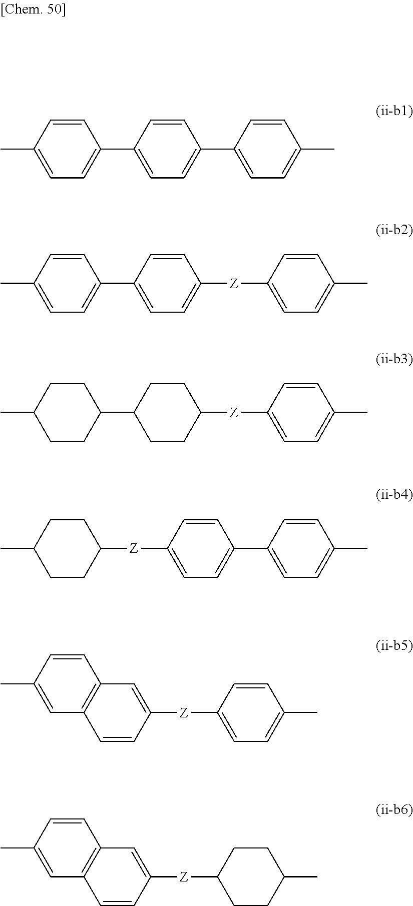

(in each of these formula, at least any one hydrogen atom of a benzene ring is optionally substituted with a fluorine atom, a methyl group, a methoxy group, —CF₃, or —OCF₃; and at least any one carbon atom of a benzene ring is optionally substituted with a nitrogen atom; and the definition of Z is the same as that in Formula (ii)) In terms of reliability, a benzene ring and a cyclohexane ring are preferred rather than a heterocycle such as a pyridine ring or a pyrimidine ring. A compound having a heterocycle such as a pyridine ring or a pyrimidine ring is suitably used to increase dielectric anisotropy; in this case, the polarizability of the compound is relatively high. On the other hand, a compound having a hydrocarbon ring such as a benzene ring or a cyclohexane ring has a low polarizability. Accordingly, it is preferred that a proper amount be determined on the basis of the polarizability of the compound having an optically active substance.

More preferred examples of such a compound include compounds represented by General Formula (ii-a1-1).

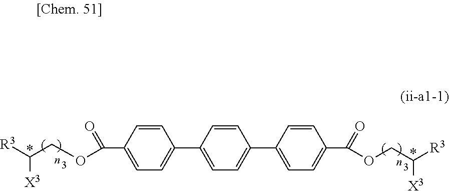

(in the formula, R³, X³, and n₃ have the same meanings as those in General Formula (ii-a1), respectively)

The chiral compound used in the ferroelectric liquid crystal composition of the present invention can be also a compound having axial chirality or an atropisomer.

In a compound in which the rotation of the bond axis is inhibited, such as the following allene derivative

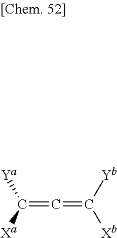

or the following biphenyl derivative,

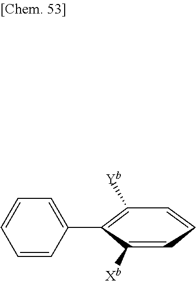

axial chirality is generated when substituents X^{a} and Y^{a} at one side of the axis are different from each other and when substituents X^{b} and Y^{b} at the other side of the axis are also different from each other. Compounds, such as biphenyl derivatives, in which the rotation of the bond axes is inhibited by an effect of, for example, steric hindrance are referred to as atropicisomers.

Examples of the compounds used in the ferroelectric liquid crystal composition of the present invention and having an axial chirality include the following compounds.

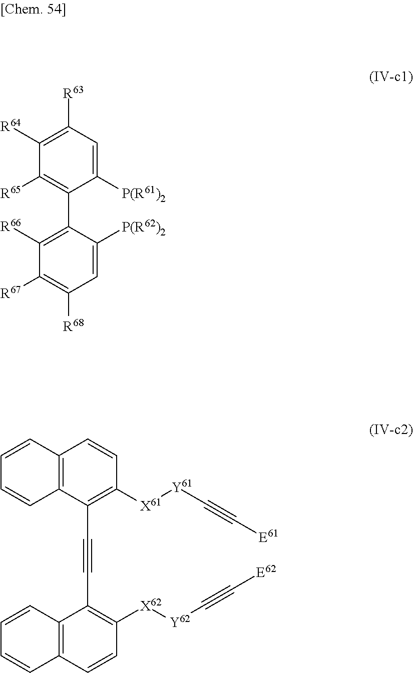

In (IV-c1) and (IV-c2), at least any one of X⁶¹ and Y⁶¹ and at least any one of X⁶² and Y⁶² are present; and X⁶¹, X⁶², Y⁶¹, and Y⁶² each independently represent CH₂, C═O, O, N, S, P, B, or Si. In the case where X⁶¹, X⁶², Y⁶¹, and Y⁶² are each N, P, B, or Si, they are optionally bonded to a substituent, such as an alkyl group, an alkoxy group, or an acyl group, so as to give a desired valence.

E⁶¹ and E⁶² each independently represent a hydrogen atom, an alkyl group, an aryl group, an allyl group, a benzyl group, an alkenyl group, an alkynyl group, an alkylether group, an alkyl ester group, an alkylketone group, a heterocyclic group, or derivatives thereof.

In Formula (IV-c1), R⁶¹ and R⁶² each independently represent a phenyl group, cyclopentyl group, or cyclohexyl group which is optionally substituted with an alkyl group, an alkoxyl group, or a halogen atom;

R⁶³, R⁶⁴, R⁶⁵, R⁶⁶, R⁶⁷, and R⁶⁸ each independently represent a hydrogen atom, an alkyl group, an alkoxyl group, an acyloxy group, a halogen atom, a haloalkyl group, or a dialkylamino group;
any two of R⁶³, R⁶⁴, and R⁶⁵ optionally form a methylene chain optionally having a substituent or a mono- or polymethylenedioxy group optionally having a substituent; and
any two of R⁶⁶, R⁶⁷, and R⁶⁸ optionally form a methylene chain optionally having a substituent or a mono- or polymethylenedioxy group optionally having a substituent. Compounds in which both R⁶⁵ and R⁶⁶ are hydrogen atoms are excluded.

The chiral compound used in the ferroelectric liquid crystal composition of the present invention can be a compound having a planar chirality.

Examples of the compound having a planar chirality include helicene derivatives represented by the following formula.

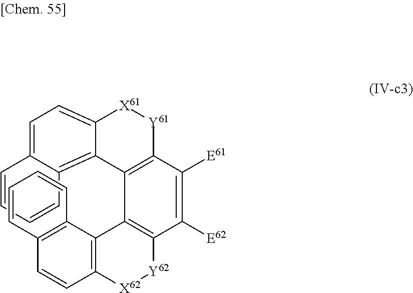

(in the formula, at least any one of X⁶¹ and Y⁶¹ and at least any one of X⁶² and Y⁶² are present; X⁶¹, X⁶², Y⁶¹, and Y⁶² each independently represent CH₂, C═O, O, N, S, P, B, or Si; in the case where X⁶¹, X⁶², Y⁶¹, and Y⁶² are each N, P, B, or Si, they are optionally bonded to a substituent, such as an alkyl group, an alkoxy group, or an acyl group, so as to give a desired valence; and

E⁶¹ and E⁶² each independently represent a hydrogen atom, an alkyl group, an aryl group, an allyl group, a benzyl group, an alkenyl group, an alkynyl group, an alkylether group, an alkyl ester group, an alkylketone group, an heterocyclic group, or derivatives thereof)

In such helicene derivatives, since the overlapping rings cannot freely change the positional relationship, a right-handed helical structure of rings and a left-handed helical structure of rings are distinguished from each other, which generates chirality.

A chiral compound used in the liquid crystal composition is preferably a compound having a large helical twisting power which enables small pitch of the helical structure. The necessary amount of the compound having a large helical twisting power for obtaining a predetermined pitch can be small; hence, an increase in a driving voltage can be suppressed, and such a compound is therefore preferred. From this point of view, examples of a preferred chiral compound include compounds having asymmetric atoms

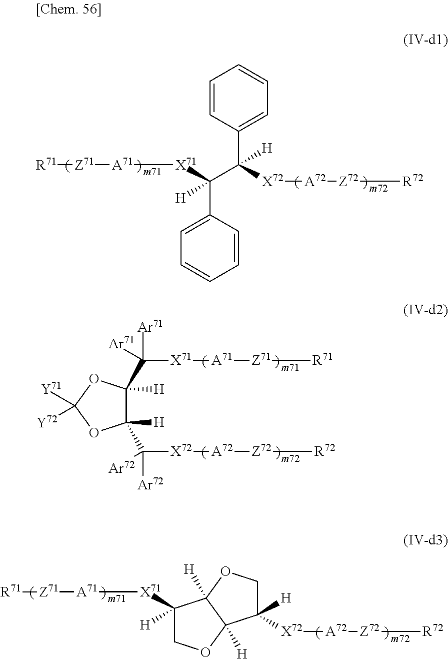

and compounds having axial chirality.

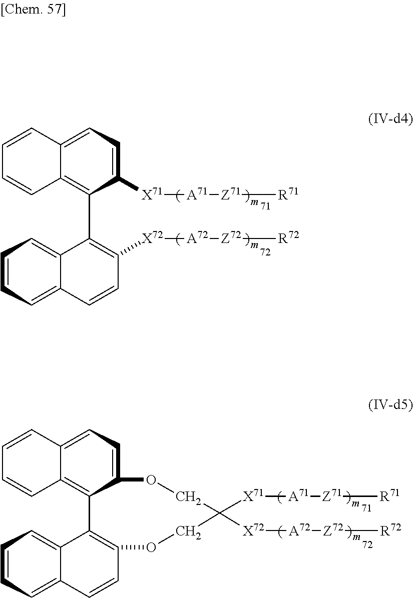

In Formulae (IV-d1) to (IV-d5), R⁷¹ and R⁷² each independently represent a hydrogen atom, a halogen atom, a cyano (CN) group, an isocyanate (NCO) group, an isothiocyanate (NCS) group, or an alkyl group having 1 to 20 carbon atoms; in the alkyl group, at least any one —CH₂— group is optionally substituted with —O—, —S—, —COO—, —OCO—, —CH═CH—, —CF═CF—, or —C≡C—; any hydrogen atom of the alkyl group is optionally substituted with a halogen atom;

A⁷¹ and A⁷² each independently represent an aromatic or non-aromatic 3- to 8-membered ring or a fused ring having 9 or more carbon atoms, in which arbitrary hydrogen atoms of these rings are each optionally substituted with a halogen atom or an alkyl or haloalkyl group having 1 to 3 carbon atoms, in which one or more —CH₂— groups of each ring are each optionally substituted with —O—, —S—, or —NH—, and in which one or more —CH═ groups of each ring are each optionally substituted with —N═;

Z⁷¹ and Z⁷² each independently represent a single bond or an alkylene group having 1 to 8 carbon atoms; any —CH₂— group is optionally substituted with —O—, —S—, —COO—, —OCO—, —CSO—, —OCS—, —N═N—, —CH═N—, —N═CH—, —N(O)═N—, —N═N(O)—, —CH═CH—, —CF═CF—, or —C≡C—; any hydrogen atom is optionally substituted with a halogen atom;

X⁷¹ and X⁷² each independently represent a single bond, —COO—, —OCO—, —CH₂O—, —OCH₂—, —CF₂O—, —OCF₂—, or —CH₂CH₂—; m₇₁ and m₇: each independently represent an integer form 1 to 4; and in Formula (IV-d5), any one of min and m₇₂ is optionally 0.

In Formula (IV-d2), Ar⁷¹ and Ar⁷² each independently represent a phenyl group or a naphthyl group; in each of these groups, at least any one hydrogen atom of the benzene ring is optionally substituted with a halogen atom (F, Cl, Br, or I), a methyl group, a methoxy group, —CF₃, or —OCF₃.

In the liquid crystal composition of the present invention, a chiral compound having a mesogen can be also used. Examples of such a chiral compound include the following compounds.

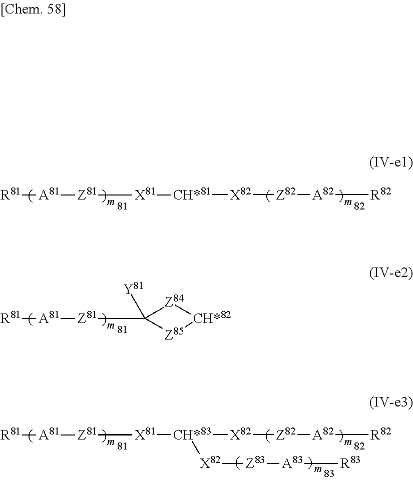

In Formulae (IV-e1) to (IV-e3),

R⁸¹, R⁸², R⁸³, and Y⁸¹ each independently represent a linear or branched alkyl group having 1 to 30 carbon atoms, a hydrogen atom, or a fluorine atom; in the alkyl group, one —CH₂— group or two or more —CH₂— groups not adjoining each other are each optionally substituted with —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—; in the alkyl group, at least one hydrogen atom is optionally substituted with a fluorine atom, a chlorine atom, a bromine atom, or a CN group; the alkyl group optionally has a polymerizable group; the alkyl group optionally contains a fused or spiro ring system; the alkyl group optionally contains one or more aromatic or aliphatic rings which optionally contain one or more hetero atoms and which are each optionally substituted with an alkyl group, an alkoxy group, or a halogen atom;

Z⁸¹, Z⁸², Z⁸³, Z⁸⁴, and Z⁸⁵ each independently represent an alkylene group having 1 to 40 carbon atoms; in the alkyl group, one or more CH₂ groups are optionally substituted with —O—, —S—, —NH—, —N(CH₃)—, —CO—, —COO—, —OCO—, —OCOO—, —S—CO—, —CO—S—, —CH═CH—, —CH═CF—, —CF═CH—, —CF═CF—, —CF₂—, or —C≡C—;

X⁸¹, X⁸², and X⁸³ each independently represent —O—, —S—, —CO—, —COO—, —OCO—, —OCOO—, —CO—NH—, —NH—CO—, —CH₂CH₂—, —OCH₂—, —CH₂O—, —SCH₂—, —CH₂S—, —CF═CF—, —CH═CH—, —OCO—CH═CH—, —C≡C—, or a single bond;

A⁸¹, A⁸², and A⁸³ each independently represent a cyclic group selected from a phenylene group, a cyclohexylene group, a dioxolanediyl group, a cyclohexenylene group, a bicyclo[2.2.2]octylene group, a piperidinediyl group, a naphthalenediyl group, a decahydronaphthalenediyl group, a tetrahydronaphthalenediyl group, and an indanediyl group; in the phenylene group, the naphthalenediyl group, the tetrahydronaphthalenediyl group, and the indanediyl group, at least one —CH═ group in each ring is optionally substituted with a nitrogen atom; in the cyclohexylene group, the dioxolanediyl group, the cyclohexenylene group, the bicyclo[2.2.2]octylene group, the piperidinediyl group, the decahydronaphthalenediyl group, the tetrahydronaphthalenediyl group, and the indanediyl group, one —CH₂— group or two —CH₂— groups not adjoining each other in each ring are optionally substituted with —O— and/or —S—; at least one hydrogen atom of each cyclic group is optionally substituted with a fluorine atom, a chlorine atom, a bromine atom, a CN group, an NO₂ group, or an alkyl, alkoxy, alkylcarbonyl, or alkoxycarbonyl group which has 1 to 7 carbon atoms and of which one or more hydrogen atoms are each optionally substituted with a fluorine atom or a chlorine atom;

m₈₁, m₈₂, and m₈₃ are each 0 or 1; m₈₁+m₈₂+m₈₃ is 1, 2, or 3;
CH*⁸¹ and CH*⁸² each independently represent a chiral divalent group; and CH*⁸³ represents a chiral trivalent group.

The chiral divalent group which each of CH*⁸¹ and CH*⁸² represents is preferably any of the following divalent groups having asymmetric atoms

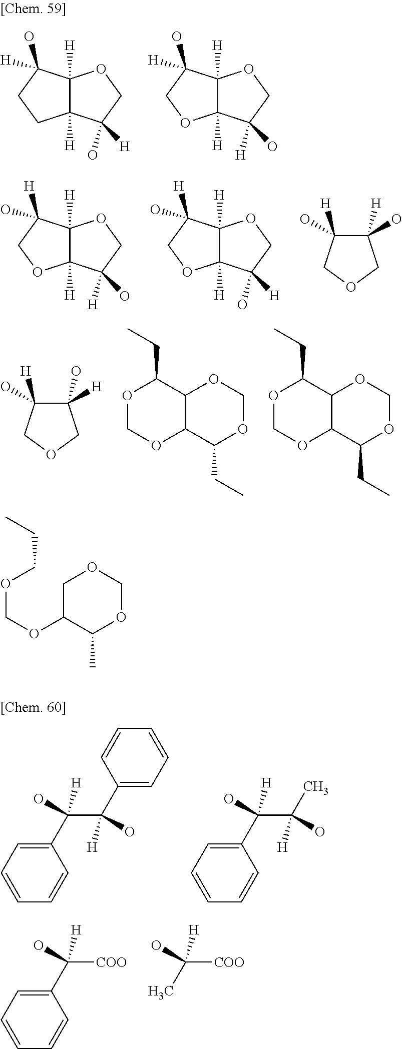

or the following divalent group having axial chirality.

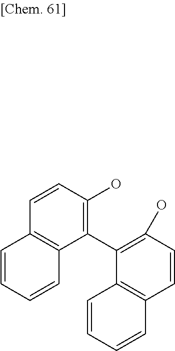 [SMILES: Oc1ccc2ccccc2c1-c1c(O)ccc2ccccc12]

In each of these divalent groups which CH*⁸¹ and CH*⁸² represent, at least any one hydrogen atom of a benzene ring is optionally substituted with a fluorine atom, a methyl group, a methoxy group, —CF₃, or —OCF₃; and at least any one carbon atom of a benzene ring is optionally substituted with a nitrogen atom.

The chiral trivalent group which CH*⁸³ represents may be any trivalent group formed by bonding of —X⁸³(Z⁸³A⁸³)ₘ₈₃R⁸³ to any position of the chiral divalent group which each of CH*⁸¹ and CH*⁸² represents.

The following compound having an isosorbide skeleton as the chiral divalent group is preferred.

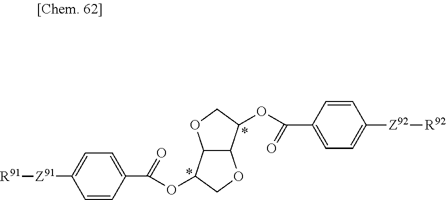

In the formula, R⁹¹ and R⁹² each independently represent a linear or branched alkyl group having 1 to 30 carbon atoms, a hydrogen atom, or a fluorine atom; in the alkyl group, one —CH₂— group or two or more —CH₂— groups not adjoining each other are each optionally substituted with —O—, —S—, —NH—, —N(CH₃)—, —CO—, —CO—O—, —O—CO—, —O—CO—O—, —S—CO—, —CO—S—, —O—SO₂—, —SO₂—O—, —CH═CH—, —C≡C—, a cyclopropylene group, or —Si(CH₃)₂—; in the alkyl group, at least one hydrogen atom is optionally substituted with a fluorine atom, a chlorine atom, a bromine atom, or a CN group; the alkyl group optionally has a polymerizable group; the alkyl group optionally contains a fused or spiro ring system; the alkyl group optionally contains one or more aromatic or aliphatic rings which optionally contain one or more hetero atoms and which are each optionally substituted with an alkyl group, an alkoxy group, or a halogen atom;

Z⁹¹ and Z⁹² each independently represent —O—, —S—, —CO—, —CO—O—, —O—CO—, —O—CO—O—, —CO—N(R^{a})—, —N(R^{a})—CO—, —OCH₂—, —CH₂O—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═CH—, —CF═CH—, —CH═CF—, —CF═CF—, —C≡C—, —CH═CH—CO—O—, —O—CO—CH═CH—, or a single bond; and R^{a} of —CO—N(R^{a})— or —N(R^{a})—CO— represents a hydrogen atom or a linear or branched alkyl group having 1 to 4 carbon atoms.

The chiral compound represented by General Formula (ii) is added to a host liquid crystal composition that mainly contains a group of the compounds represented by General Formula (i) and that exhibits a smectic C phase, so that the host liquid crystal composition becomes ferroelectric. In order to produce large spontaneous polarization, the concentration of the chiral compound may be enhanced; the amount of the chiral compound can be adjusted to give the demanded physical properties such as spontaneous polarization, phase transition temperature, and a phase sequence. In order to reduce crystallization, a chiral compound of which the optically active group has a different structure from the terminal groups of the host liquid crystal is used to decrease crystallization temperature to a preferred level; note that the amount of such a chiral compound to be used has an upper limit. In order to enhance the stability (upper limit of temperature) of the ferroelectric phase, a compound containing three rings may be used to the extent that the effect of a reduction in crystallization can be maintained. In order to produce a good alignment state in a horizontal alignment cell, it is important to prolong the helical pitch in a chiral nematic phase, in particular, to prolong the helical pitch in a chiral nematic phase in the transition between a nematic phase and a smectic phase; phase transition to a smectic A phase in a state in which the spiral is unwound enables good uniaxial alignment.

In the case where the amount of a group of chiral compounds represented by General Formula (ii) (hereinafter referred to as group (ii)) is increased with the result that the helical pitch in a chiral nematic phase in the transition between a nematic phase and a smectic phase shortens to the extent that alignment is disrupted, a chiral compound that can induce the opposite chirality (sense) of the helix in a chiral nematic phase to the sense that is induced by the compound of the group (ii) is preferably used in combination with the compound of the group (ii) to prolong the helical pitch in the chiral nematic phase. In this case, any known chiral compound can be used; however, a compound having the same polarity of spontaneous polarization as the group (ii) used or a compound of which the degree of the spontaneous polarization is sufficiently smaller than that of the group (ii) used is preferred because a reduction in spontaneous polarization due to cancellation thereof can be suppressed.

In the case where the molecules are aligned by surface stabilization in a ferroelectric phase, the helical pitch in the ferroelectric phase is preferably long, and a chiral compound that can induce the opposite chirality (sense) of the helix in a ferroelectric phase to the sense that is induced by the compound of the group (ii) is preferably used in combination with the compound of the group (ii) to prolong the helical pitch in the ferroelectric phase. In this case, any known chiral compound can be used; however, a compound having the same polarity of spontaneous polarization as the group (ii) used or a compound of which the degree of the spontaneous polarization is sufficiently smaller than that of the group (ii) used is preferred because a reduction in spontaneous polarization due to cancellation thereof can be suppressed. If only polymer stabilization is employed without surface stabilization, such a chiral compound that can induce the opposite sense does not need to be added to the group (ii). In the case where the composition is used in a cell having a relatively large thickness (at least 3 m) and where a short helical pitch is needed in order to enhance the mobility of liquid crystal molecules in a polymer stabilization process for making the polymer stabilization process easier or in a polymer-stabilized state for easily enabling a gray scale to appear after the polymer stabilization, a chiral compound having a short helical pitch in a ferroelectric phase is preferably added. In this case, any known chiral compound can be added; however, a compound having the same polarity of spontaneous polarization as the group (ii) used or a compound of which the degree of the spontaneous polarization is sufficiently smaller than that of the group (ii) used is preferred because a reduction in spontaneous polarization due to cancellation thereof can be suppressed. The additive to be employed is more preferably a chiral compound which induces a sufficiently long helical pitch in a chiral nematic liquid crystal or which can cancel the helical pitch induced by the group (ii).

It is important to determine the amount of the compound represented by General Formula (ii) in the liquid crystal composition of the present invention in view of the above points about the group (ii); the amount is preferably in the range of 1 to 35 mass %, more preferably 5 to 30 mass %, and especially preferably 5 to 20 mass % relative to the total mass of the liquid crystal composition of the present invention.

The liquid crystal composition of the present invention may further contain at least one compound having a polymerizable functional group in order to produce a liquid crystal display device of a PS mode, a PSA mode involving use of a horizontal electric field, or a PSVA mode involving use of a horizontal electric field and a liquid crystal display device involving use of polymer-stabilized ferroelectric liquid crystal.

A polymer-stabilized ferroelectric liquid crystal display device in which the polymer-stabilized liquid crystal composition of the present invention is used as a material for a display is driven at a low voltage and has a high light transmittance; moreover, in such a liquid crystal display device, improved uniaxial alignment stably enables high contrast display in TFT driving, half tone which cannot be displayed by a display device using ferroelectric liquid crystal alone can be displayed, and excellent thermal and mechanical stabilities are provided.

In the ferroelectric liquid crystal composition having a polymerizable functional group according to the present invention, the radical polymerizable compound contained therein is polymerized by application of heat or irradiation with an active energy ray, such as ultraviolet, in a state in which alternating voltage has been applied, which causes the phase separation of this compound from the liquid crystal composition or allows the compound to be dispersed in the liquid crystal composition; a polymer-stabilized liquid crystal display device includes a transparent polymer and the liquid crystal composition in this state.

In the case where this device is a liquid crystal device including a pair of substrates each having an electrode layer and an alignment-controlling film and liquid crystal layer each interposed therebetween, the liquid crystal layer contains a ferroelectric liquid crystal material and the photo-cured product of a photocurable composition containing at least a polymeric precursor of liquid crystal (polymerizable liquid crystal); and polymer stabilization is carried out such that the alignment direction of the mesogenic group of the polymerizable liquid crystal and the alignment direction of the ferroelectric liquid crystal material are uniaxially aligned with the alignment direction of the alignment-controlling film between a pair of the electrode layers. In such a liquid crystal display device, the photo-cured product derived from the polymerizable liquid crystal is dispersed in the liquid crystal layer, and the polymer chain having a liquid crystal skeleton allows the alignment stabilization of the ferroelectric liquid crystal material, which enables an alignment state in which the longitudinal direction of the liquid crystal skeleton of the liquid crystal monomer can be aligned with the alignment direction of the ferroelectric liquid crystal material or the averaged alignment direction of the ferroelectric liquid crystal molecules in a state in which voltage is not applied. In addition, application of voltage causes spontaneous polarization of the ferroelectric liquid crystal, and thus the alignment direction of the ferroelectric liquid crystal material is misaligned with the alignment direction of the liquid crystal skeleton of the polymeric precursor of the liquid crystal; then, controlling the voltage continuously changes the angle defined by the alignment direction of the liquid crystal skeleton of the liquid crystal monomer and the alignment direction of the ferroelectric liquid crystal material or the averaged alignment direction.

Such a device is, for example, disposed between two polarizing plates, and voltage to be applied is changed, thereby being able to continuously control the amount of light to be transmitted and to display half tone in proportion to voltage to be applied without any specific means such as area coverage modulation that can be made in a device in which ferroelectric liquid crystal is used alone.

The above-mentioned uniaxial alignment can be provided by aligning the direction of the mesogenic group or the longitudinal axis of the polymer main chain through a technique which involves use of a an alignment film of a polymer, such as polyimide, rubbed in a uniaxial direction, a technique which involves use of an inorganic alignment film, a technique which involves use of an optical alignment film, a technique which involves use of an external field such as an electric field or a magnetic field, or a technique which involves combined use of an alignment film and an external field and then radiating ultraviolet in this state for polymer stabilization.

In use of polymer-stabilized liquid crystal, the average size of gaps in the cross-linked structure of a polymer needs not to be within the wavelength region of visible light that is from approximately 500 nm to approximately 1500 nm so as to prevent light scattering. The size of the gap can be made to be not more than 500 nm by a technique which involves utilizing a process of phase separation due to spinodal decomposition, a technique in which a UV polymerization rate is enhanced in a production process (technique based on a process of UV polymerization or based on adjustment of the composition of the polymeric precursor), or a technique in which polymerization is carried out with almost no phase separation caused in a state in which low molecular weight liquid crystal is dissolved as well; it is preferred that these techniques be effectively used to produce a network polymer having a fine structure that eliminates light scattering. In addition, light scattering is also preferably prevented by forming a polymer layer having a roughness on the surface of a substrate of the liquid crystal cell, forming a protrusion of a polymer, or forming a fine polymer fiber.

In the case where a monomer is dissolved in low molecular weight liquid crystal, a network polymer can be formed in a state in which the monomer is dispersed in the low molecular weight liquid crystal, and a fine structure in a molecular order can be produced; thus this is preferred.

However, if polymerization of the monomer used in the present invention in a liquid crystal phase locally causes polymerization microphase separation, formation of a network polymer is observed along the director of liquid crystal molecules with electron microscope, although the alignment order is not high. This is because the longitudinal direction of the monomer molecules tends to align with the direction of the director of liquid crystal molecules when the monomer contacts the liquid crystal, and thus alignment of the liquid crystal is fixed by polymerization of the monomer. When the concentration of the monomer increases, however, a phase separation structure is formed by spinodal or binodal decomposition caused by polymerization microphase separation regardless of alignment of the liquid crystal, which makes it impossible to fix the intended alignment of the liquid crystal. The above method may disturb alignment of the low molecular weight liquid crystal; in this case, in order to obtain the desired stable alignment, the external field can be adjusted to produce the intended polymer-stabilized liquid crystal device through making use of, for instance, an electric field, the alignment-controlling force of an alignment film, or an external magnetic field. Furthermore, a copolymer of multiple types of polymerizable liquid crystal may be used to form a periodic structure having regularity through applying the self-organization property of a mesogen group or the self-organization based on a hydrogen-bonding group. A particulate polymer may be dispersed in a low molecular weight liquid crystal if it is necessary for obtaining desired characteristics.

In order to fix a state in which liquid crystal is aligned by use of, for example, an alignment film without defective alignment, it is preferred that temperature be slowly decreased at least from a nematic phase to induce phase transition to smectic phase, and it is more preferred that a liquid crystal cell to be used have a substrate with a flat surface. The monomer also needs to be polymerized into a network structure or a dispersed state in a liquid crystal phase such as a nematic or smectic phase. Furthermore, in order to avoid formation of the phase separation structure, it is preferred to reduce the monomer content and adjust the polymeric precursor content and the composition of the precursor so as to form a network polymer between liquid crystal molecules in a state in which the liquid crystal molecules are aligned. In the case of photopolymerization, the time and intensity of the UV exposure and temperature are preferably adjusted to form a network polymer, thereby eliminating the defective alignment of liquid crystal molecules.

In order to obtain desired alignment of liquid crystal molecules in the polymerization of a monomer in the composition, it is possible to use a liquid crystal cell including an alignment film, which has been subjected to a rubbing alignment treatment of vertical alignment, parallel alignment, or anti-parallel alignment or a photoalignment treatment, or an alignment film, in which the shape effect of an inorganic substance is utilized, or to use a liquid crystal cell in which upper and lower substrates include a vertical alignment film or a combination of the vertical alignment film and a parallel alignment. Furthermore, a predetermined polymer-stabilized liquid crystal display device can be produced by forming twist alignment, bent alignment, spray alignment, or parallel alignment through exposure to light, heat, voltage, or external field such as a magnetic field or forming a liquid crystal alignment state which is not easily obtained with an alignment film alone and by then fixing the formed alignment state through polymerization of the monomer.

In the case of a smectic phase, for example, the desired polymer-stabilized liquid crystal display device can also be produced by polymer stabilization made in an alignment state in which directors are aligned in a given direction owing to an external field or by fixing of a transitional alignment state through polymerization brought about by switching.

Examples of a polymerizable compound usable in such a device include photo-polymerizable monomers which are polymerized by being irradiated with an energy ray such as light; in particular, polymerizable compounds each having a liquid crystal structure in which multiple six-membered rings are bonded to each other, such as biphenyl derivatives and terphenyl derivatives, can be employed.

The polymerizable compounds usable in the present invention will now be specifically described.

<Polymerizable Compound (I)>

A polymerizable compound (I) used in the present invention is preferably any of polymerizable compounds represented by General Formula (I-a).

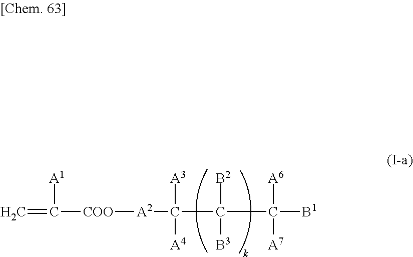

(in Formula (I-a),

A¹ represents a hydrogen atom or a methyl group;
A² represents a single bond or an alkylene group having 1 to 15 carbon atoms (one or more methylene groups in the alkylene group are each independently optionally substituted with an oxygen atom, —CO—, —COO—, or —OCO— such that oxygen atoms are not directly bonded to each other; and one or more hydrogen atoms in the alkylene group are each independently optionally substituted with a fluorine atom, a methyl group, or an ethyl group);
A³ and A⁶ each independently represent a hydrogen atom or an alkyl group having 1 to 18 carbon atoms (one or more methylene groups in the alkyl group are each independently optionally substituted with an oxygen atom, —CO—, —COO—, or —OCO— such that oxygen atoms are not directly bonded to each other; and one or more hydrogen atoms in the alkyl group are each independently optionally substituted with a halogen atom other than a chlorine atom or an alkyl group having 1 to 17 carbon atoms);
A⁴ and A⁷ each independently represent a hydrogen atom or an alkyl group having 1 to 10 carbon atoms (one or more methylene groups in the alkyl group are each independently optionally substituted with an oxygen atom, —CO—, —COO—, or —OCO— such that oxygen atoms are not directly bonded to each other; and one or more hydrogen atoms in the alkyl group are each independently optionally substituted with a halogen atom other than a chlorine atom or an alkyl group having 1 to 9 carbon atoms);
k represents 1 to 40;
B¹, B², and B³ each independently represent a hydrogen atom, a linear or branched alkyl group having 1 to 10 carbon atoms (one or more methylene groups in the alkyl group are each independently optionally substituted with an oxygen atom, —CO—, —COO—, or —OCO— such that oxygen atoms are not directly bonded to each other), or a structure represented by General Formula (I-b)

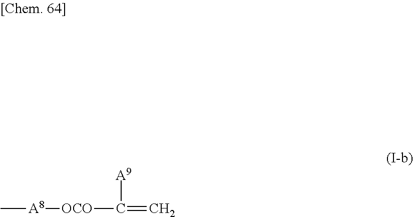

(in Formula (I-b), A⁹ represents a hydrogen atom or a methyl group;

A⁸ represents a single bond or an alkylene group having 1 to 15 carbon atoms (one or more methylene groups in the alkylene group are each independently optionally substituted with an oxygen atom, —CO—, —COO—, or —OCO— such that oxygen atoms are not directly bonded to each other; and one or more hydrogen atoms in the alkylene group are each independently optionally substituted with a fluorine atom, a methyl group, or an ethyl group); and among B¹, B^{Z}, and B³ which are present in the total number of 2k+1, the number of the structures represented by General Formula (I-b) is in the range of 0 to 3) The glass transition temperature of the polymer of such a polymerizable compound is preferably in the range of −100° C. to 25° C.

In the present invention, the term “alkylene group” refers to a divalent group “—(CH₂)ₙ—” (n is an integer of 1 or more) formed by extracting one hydrogen atom from each of the carbon atoms at the two terminals of a linear aliphatic hydrocarbon, unless otherwise specified. In the case where the hydrogen atom is substituted with a halogen atom or an alkyl group or where a methylene group is substituted with an oxygen atom, —CO—, —COO—, or —OCO—, such substitution is specified. The term “alkylene chain length” refers to n in the general formula “—(CH₂)ₙ—” of “alkylene group”.

The non-liquid crystal monomer (I) may be a combination of compounds represented by General Formula (I-a) in which there are differences in the length of the main chain and in the length of the alkyl side chain.

A preferred polymerizable compound (I) represented by General Formula (I-a) is at least one compound selected from the group consisting of compounds represented by General Formulae (I-c), (I-d), (I-e), and (I-f).

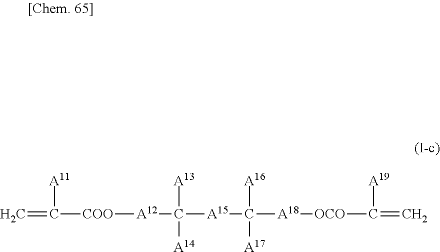

(in Formula (I-c), A¹¹ and A¹⁹ each independently represent a hydrogen atom or a methyl group; A¹² and A¹³ each independently represent a single bond or an alkylene group having 1 to 15 carbon atoms (one or more methylene groups in the alkylene group are each independently optionally substituted with an oxygen atom, —CO—, —COO—, or —OCO— such that oxygen atoms are not directly bonded to each other; and one or more hydrogen atoms in the alkylene group are each independently optionally substituted with a fluorine atom, a methyl group, or an ethyl group);

A¹³ and A¹⁶ each independently represent a linear alkyl group having 2 to 20 carbon atoms (one or more methylene groups in the linear alkyl group are each independently optionally substituted with an oxygen atom, —CO—, —COO—, or —OCO— such that oxygen atoms are not directly bonded to each other);
A¹⁴ and A¹⁷ each independently represent a hydrogen atom or an alkyl group having 1 to 10 carbon atoms (one or more methylene groups in the alkyl group are each independently optionally substituted with an oxygen atom, —CO—, —COO—, or —OCO— such that oxygen atoms are not directly bonded to each other; and one or more hydrogen atoms in the alkyl group are each independently optionally substituted with a halogen atom or an alkyl group having 1 to 9 carbon atoms); and
A¹⁵ represents an alkylene group having 9 to 16 carbon atoms (in at least one to five methylene groups in the alkylene group, one hydrogen atom of each methylene group is independently substituted with a linear or branched alkyl group having 1 to 10 carbon atoms; and one or more methylene groups in the alkylene group are each independently optionally substituted with an oxygen atom, —CO—, —COO—, or —OCO— such that oxygen atoms are not directly bonded to each other)

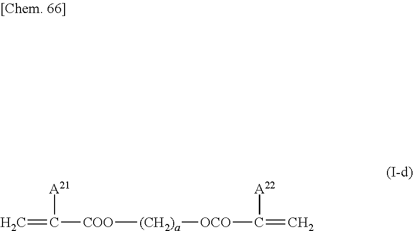

(in Formula (I-d), A²¹ and A²² each independently represent a hydrogen atom or a methyl group, and a represents an integer from 6 to 22)

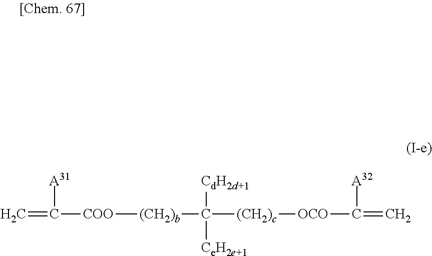

(in Formula (I-e), A³¹ and A³² each independently represent a hydrogen atom or a methyl group,

b and c each independently represent an integer from 1 to 10, d represents an integer from 1 to 10, and e represents an integer from 0 to 6)

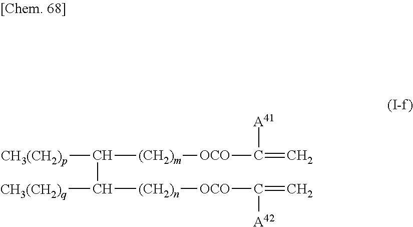

(in Formula (I-f), A⁴¹ and A⁴² each independently represent a hydrogen atom or a methyl group; and

m, n, p, and q each independently represent an integer from 1 to 10) Among these compounds, a compound represented by Formula (I-c) is preferably employed.

In a preferred structure of the polymerizable compound represented by General Formula (I-c), A¹¹ and A¹⁹ are each a hydrogen atom. The effects of the present invention can be provided even by use of a compound in which the substituents A¹¹ and A¹⁹ are each a methyl group; however, the compound in which A¹¹ and A¹⁹ are each a hydrogen atom enables an increase in a polymerization rate and thus is beneficial.

A¹² and A¹⁸ are preferably each independently a single bond or an alkylene group having 1 to 3 carbon atoms. The distance between the two polymerizable functional groups can be adjusted by an independent change in the carbon chain length of each of A¹², A¹⁸, and A¹⁵. The compound represented by General Formula (I-c) is characterized in that the distance between polymerizable functional groups (distance between crosslinking points) is long; however, an excessive distance therebetween makes the polymerization rate extremely slow and results in an adverse effect on phase separation, and the distance between polymerizable functional groups therefore has an upper limit. The distance between two side chains A¹³ and A¹⁶ has an effect on the mobility of the main chain. In particular, a small distance between the side chains A¹³ and A¹⁶ causes the interference between A¹³ and A¹⁶, which results in a reduction in the mobility. Accordingly, the distance between polymerizable functional groups in the compound represented by General Formula (I-c) is determined by the sum total of the lengths of A¹², A¹³, and A¹⁵.

It is preferred that the length of A¹⁵ be increased rather than those of A¹² and A¹⁸.

The lengths of the side chains A¹³, A¹⁴, A¹⁶, and A¹⁷ are preferably as follows.

In General Formula (I-c), A¹³ and A¹⁴ are bonded to the same carbon atom in the main chain; in the case where they have different lengths, the side chain having a longer length is referred to as A¹³ (if A¹³ and A¹⁴ have the same length, any one of them can be referred to as A¹³). Similarly, in the case where A¹⁶ and A¹⁷ have different lengths, the side chain having a longer length is referred to as A¹⁶ (if A¹⁶ and A¹⁷ have the same length, any one of them can be referred to as A¹⁶).

Such A¹³ and A¹⁶ are each independently a linear alkyl group having 2 to 20 carbon atoms in the present invention (one or more methylene groups in the linear alkyl group are each independently optionally substituted with an oxygen atom, —CO—, —COO—, or —OCO— such that oxygen atoms are not directly bonded to each other);

preferably each independently a linear alkyl group having 2 to 18 carbon atoms (one or more methylene groups in the linear alkyl group are each independently optionally substituted with an oxygen atom, —CO—, —COO—, or —OCO— such that oxygen atoms are not directly bonded to each other); and

more preferably each independently a linear alkyl group having 3 to 15 carbon atoms (one or more methylene groups in the linear alkyl group are each independently optionally substituted with an oxygen atom, —CO—, —COO—, or —OCO— such that oxygen atoms are not directly bonded to each other).

Since a side chain has a higher mobility than the main chain, the presence of the side chain contributes to an improvement in the mobility of a polymer chain at low temperature; however, the occurrence of the above-mentioned spatial interference between two side chains reduces the mobility. In order to inhibit the spatial interference between side chains, it is effective to increase the distance between the side chains and to decrease the lengths of the side chains within a necessary range.

A¹⁴ and A¹⁷ are each independently a hydrogen atom or an alkyl group having 1 to 10 carbon atoms in the present invention (one or more methylene groups in the alkyl group are each independently optionally substituted with an oxygen atom, —CO—, —COO—, or —OCO— such that oxygen atoms are not directly bonded to each other; and one or more hydrogen atoms in the alkyl group are each independently optionally substituted with a halogen atom other than a chlorine atom or an alkyl group having 1 to 9 carbon atoms);

preferably each independently a hydrogen atom or an alkyl group having 1 to 7 carbon atoms (one or more methylene groups in the alkyl group are each independently optionally substituted with an oxygen atom, —CO—, —COO—, or —OCO— such that oxygen atoms are not directly bonded to each other);

more preferably each independently a hydrogen atom or an alkyl group having 1 to 5 carbon atoms (one or more methylene groups in the alkyl group are each independently optionally substituted with an oxygen atom, —CO—, —COO—, or —OCO— such that oxygen atoms are not directly bonded to each other); and

further preferably each independently a hydrogen atom or an alkyl group having 1 to 3 carbon atoms (one or more methylene groups in the alkyl group are each independently optionally substituted with an oxygen atom, —CO—, —COO—, or —OCO— such that oxygen atoms are not directly bonded to each other).

Also in A¹⁴ and A¹⁷, the extraordinary lengths thereof cause spatial interference between the side chains and are therefore not preferred. In the case where the side chains A¹⁴ and A¹⁷ are alkyl chains each having a short length, it is believed that they can have high mobility and inhibit an approach between adjacent main-chain moieties and that they can prevent interference between polymer main-chain moieties with the result that the mobility of the main chain is enhanced, which can prevent an increase in anchoring energy at low temperature and is effective for improving the properties of a polymer-stabilized liquid crystal optical device in a low temperature region.

A¹⁵ positioned between the two side chains preferably has a long length from a viewpoint of a change in the distance between the side chains and from a viewpoint of an increase in the distance between crosslinking points for a reduction in the glass transition temperature. The extraordinary length of A¹⁵, however, causes the molecular weight of the compound represented by General Formula (I-c) to be unnecessarily large, which reduces the compatibility with a liquid crystal composition and causes a polymerization rate to be too slow with the result that the phase separation is adversely affected. Hence, the upper limit of the length needs to be determined.

Accordingly, in the present invention, A¹⁵ is preferably an alkylene group having 9 to 16 carbon atoms (one hydrogen atom of each of at least one to five methylene groups in the alkylene group is independently substituted with a linear or branched alkyl group having 1 to 10 carbon atoms, and one or more methylene groups in the alkylene group are each independently optionally substituted with an oxygen atom, —CO—, —COO—, or —OCO— such that oxygen atoms are not directly bonded to each other).

That is, in the present invention, A¹⁵ preferably has an alkylene chain length of 9 to 16 carbon atoms. A¹⁵ has, as a structural characteristic, a structure in which a hydrogen atom of the alkylene group is substituted with an alkyl group having 1 to 10 carbon atoms. The number of substitutions with the alkyl group is from one to five, preferably one to three, and more preferably two or three. The number of carbon atoms of the alkyl group as a substituent is preferably from one to five, and more preferably one to three.

The compound represented by General Formula (I-a) can be synthesized by known methods such as techniques disclosed in Tetrahedron Letters; Vol. 30; pp 4985, Tetrahedron Letters; Vol. 23, No 6; pp 681-684, and Journal of Polymer Science: Part A: Polymer Chemistry; Vol. 34; pp 217-225.

A compound represented by General Formula (I-c) in which A¹⁴ and A¹⁷ are hydrogen atoms can be, for example, prepared as follows: a compound having multiple epoxy groups is allowed to react with a polymerizable compound having active hydrogen which is reactive with the epoxy groups, such as acrylic acid or methacrylic acid, thereby synthesizing a hydroxyl-group-containing polymerizable compound; and then the resulting compound is allowed to react with saturated fatty acid.

Alternatively, the compound can be prepared as follows: a compound having multiple epoxy groups is allowed to react with saturated fatty acid, thereby synthesizing a hydroxyl-group-containing compound; and the hydroxyl-group-containing compound is allowed to react with a polymerizable compound having a group that is reactive with a hydroxyl group, such as an acrylic acid chloride.

A radically polymerizable compound represented by General Formula (I-c), for instance, in which A¹⁴ and A¹⁷ are alkyl groups and in which A¹² and A¹⁸ are methylene groups each having one carbon atom can be prepared as follows: a compound having multiple oxetane groups is allowed to react with a compound that is reactive with the oxetane groups, such as a fatty acid chloride or fatty acid, and the reaction product is further allowed to react with a polymerizable compound having active hydrogen, such as acrylic acid; or a compound having one oxetane group is allowed to react with a polyvalent fatty acid chloride or fatty acid that is reactive with the oxetane group, and the reaction product is further allowed to react with a polymerizable compound having active hydrogen, such as acrylic acid.

A polymerizable compound represented by General Formula (I-c) in which A¹² and A¹⁸ are alkylene groups each having three carbon atoms (propylene group:—CH₂CH₂CH₂—) can be prepared by use of a compound having multiple furan groups instead of the oxetane groups. A polymerizable compound represented by General Formula (I-c) in which A¹² and A¹⁸ are alkylene groups each having four carbon atoms (butylene group:—CH₂CH₂CH₂CH₂—) can be prepared by use of a compound having multiple pyran groups instead of the oxetane groups.

<Polymerizable Liquid Crystal Compound (II)>

A polymerizable liquid crystal compound (II) used in the present invention is at least one polymerizable compound (II) selected from the group consisting of compounds represented by General Formulae (II-a)

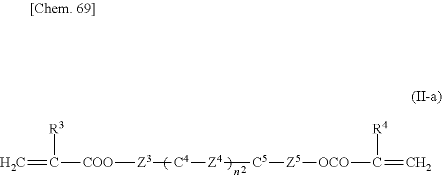

(in Formula (II-a), R³ and R⁴ each independently represent a hydrogen atom or a methyl group; C⁴ and C⁵ each independently represent a 1,4-phenylene group, a 1,4-cyclohexylene group, a pyridine-2,5-diyl group, a 1,3-dioxane-2,5-diyl group, a cyclohexene-1,4-diyl group, a decahydronaphthalene-2,6-diyl group, a 1,2,3,4-tetrahydronaphthalene-2,6-diyl group, a 2,6-naphthylene group, or an indane-2,5-diyl group (among these groups, the 1,4-phenylene group, the 1,2,3,4-tetrahydronaphthalene-2,6-diyl group, the 2,6-naphthylene group, and the indane-2,5-diyl group are unsubstituted or each optionally substituted with one or more of a fluorine atom, a methyl group, a trifluoromethyl group, and a trifluoromethoxy group);

Z³ and Z⁵ each independently represent a single bond or an alkylene group having 1 to 15 carbon atoms (one or more methylene groups in the alkylene group are each independently optionally substituted with an oxygen atom, —CO—, —COO—, or —OCO— such that oxygen atoms are not directly bonded to each other; and one or more hydrogen atoms in the alkylene group are each independently optionally substituted with a fluorine atom, a methyl group, or an ethyl group);
Z⁴ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —COO—, or —OCO—;
n² represents 0, 1, or 2; and in the case where n² represents 2, the multiple C⁴'s may be the same as or different from each other, and the multiple Z⁴'s may be the same as or different from each other),

General Formula (II-b)

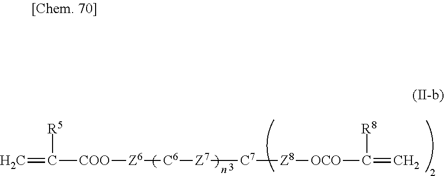

(in Formula (II-b), R⁵ and R⁶ each independently represent a hydrogen atom or a methyl group; C⁶ represents a 1,4-phenylene group, a 1,4-cyclohexylene group, a pyridazine-3,6-diyl group, a 1,3-dioxane-2,5-diyl group, a cyclohexene-1,4-diyl group, a decahydronaphthalene-2,6-diyl group, a 1,2,3,4-tetrahydronaphthalene-2,6-diyl group, a 2,6-naphthylene group, or an indane-2,5-diyl group (among these groups, the 1,4-phenylene group, the 1,2,3,4-tetrahydronaphthalene-2,6-diyl group, the 2,6-naphthylene group, and the indane-2,5-diyl group are unsubstituted or each optionally substituted with one or more of a fluorine atom, a methyl group, a trifluoromethyl group, and a trifluoromethoxy group);

C⁷ represents a benzene-1,2,4-triyl group, a benzene-1,3,4-triyl group, a benzene-1,3,5-triyl group, a cyclohexane-1,2,4-triyl group, a cyclohexane-1,3,4-triyl group, or a cyclohexane-1,3,5-triyl group;
Z⁶ and Z⁸ each independently represent a single bond or an alkylene group having 1 to 15 carbon atoms (one or more methylene groups of the alkylene group are each independently optionally substituted with an oxygen atom, —CO—, —COO—, or —OCO— such that oxygen atoms are not directly bonded to each other, and one or more hydrogen atoms of the alkylene group are each independently optionally substituted with a fluorine atom, a methyl group, or an ethyl group);
Z⁷ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —COO—, or —OCO—;
n³ represents 0, 1, or 2; and in the case where n³ represents 2, the multiple C⁶'s may be the same as or different from each other, and the multiple Z⁷'s may be the same as or different from each other),

and General Formula (II-c)

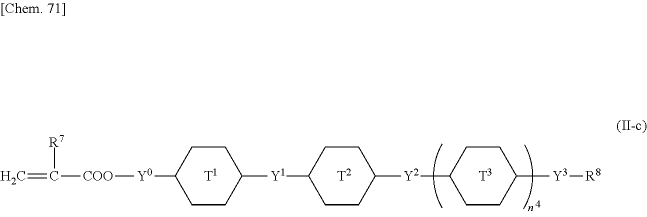

(in Formula (II-c), R⁷ represents a hydrogen atom or a methyl group; six-membered rings T¹, T², and T³ each independently represent any of the followings

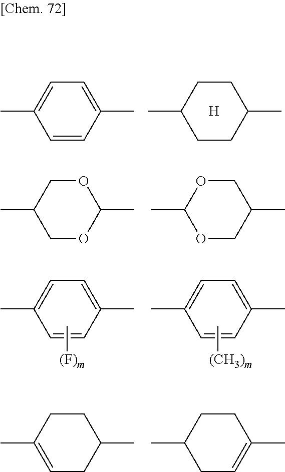

(where m represents an integer from 1 to 4);

n⁴ represents an integer of 0 or 1;
Y⁰, Y¹, and Y² each independently represent a single bond, —CH₂CH₂—, —(CH₂)ₚ₁O—, —O(CH₂)ₚ₁—, —COO—, —OCO—, —C≡C—, —CH═CH—, —CF═CF—, —(CH₂)₄—, —CH═CHCH₂CH₂—, or —CH₂CH₂CH═CH—; Y³ represents a single bond, —O—, —COO—, or —OCO— (where p1 represents an integer from 1 to 20); and
R⁸ represents a hydrogen atom, a halogen atom, a cyano group, an alkyl group having 1 to 20 carbon atoms, an alkenyl group having 1 to 20 carbon atoms, an alkoxy group having 1 to 20 carbon atoms, or a hydrocarbon group having 1 to 20 carbon atoms).

More specifically, use of any of compounds represented by General Formulae (II-d), (II-e), and (II-f) is preferred because it enables a production of optically isotropic compounds having high mechanical strength and excellent thermal resistance.

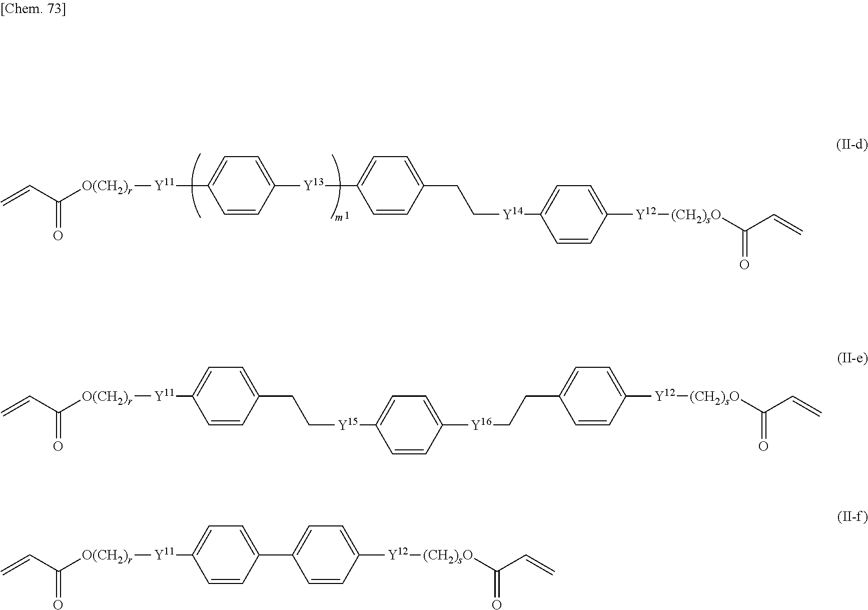

(in Formulae (II-d), (II-e), and (II-f), m¹ represents 0 or 1; Y¹¹ and Y¹² each independently represents a single bond, —O—, —COO—, or —OCO—;

Y¹³ and Y¹⁴ each independently represent —COO— or —OCO—; Y¹⁵ and Y¹⁶ each independently represent —COO— or —OCO—; r and s each independently represent an integer from 2 to 14; and the 1,4-phenylene group in each formula is unsubstituted or optionally substituted with at least one of a fluorine atom, a methyl group, a trifluoromethyl group, and a trifluoromethoxy group)

Specific examples of the compounds represented by General Formula (II-a) include the following compounds (II-1) to (II-10).

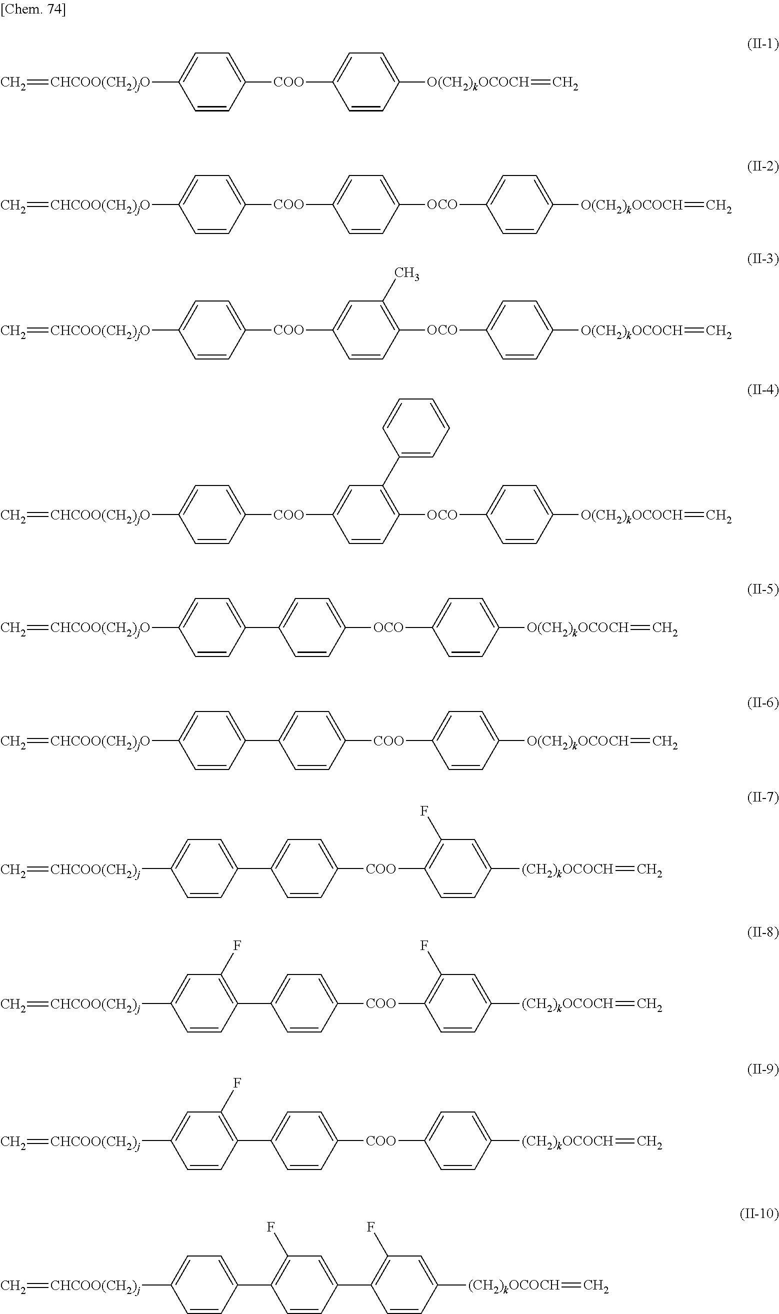

(in the formulae, j and k each independently represent an integer from 2 to 14)

Specific examples of the compounds represented by General Formula (II-d), (II-e), or (II-f) include the following compounds (II-11) to (II-19).

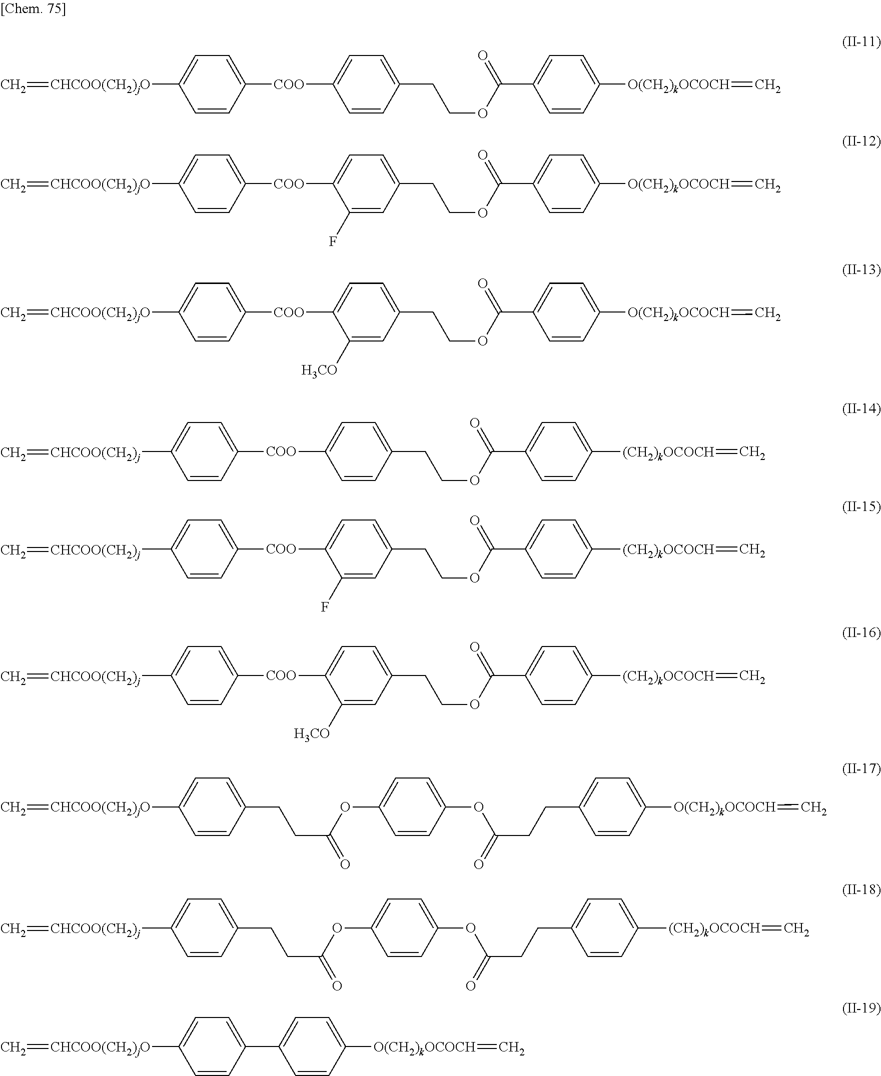

(in the formulae, j and k each independently represent an integer from 2 to 14)

<Chiral Photopolymerizable Monomer>

The photopolymerizable monomer (polymerizable compound) may be not only the above-mentioned achiral materials but also chiral materials. Examples of the chiral photopolymerizable monomer include polymerizable compounds represented by General Formula (II-x) or (II-y).

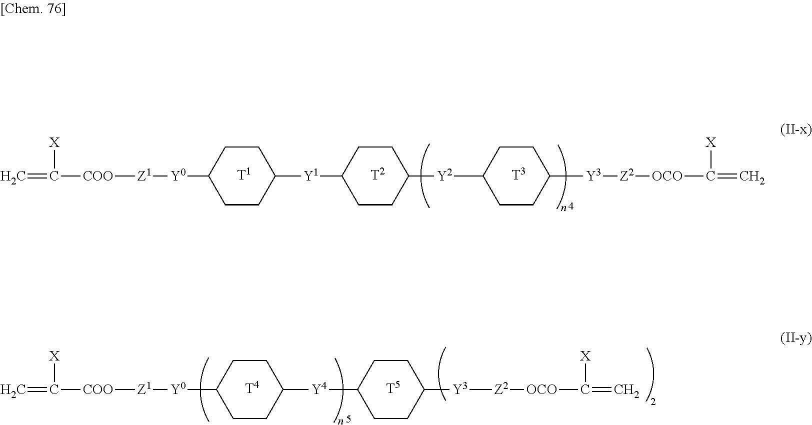

In Formulae (II-x) and (II-y), X represents a hydrogen atom or a methyl group. n⁴ represents an integer of 0 or 1, and n⁵ represents an integer of 0, 1, or 2. In the case where n⁵ represents 2, the multiple T⁴'s may be the same as or different from each other, and the multiple Y⁴'s may be the same as or different from each other.

The six-membered rings T¹, T², T³, and T⁴ each represent a substituent having a six-membered ring structure, such as a 1,4-phenylene group or a trans-1,4-cyclohexylene group. Each of the six-membered rings T¹, T², and T³ is not limited to such a substituent and may be a substituent having any one of the following structures.

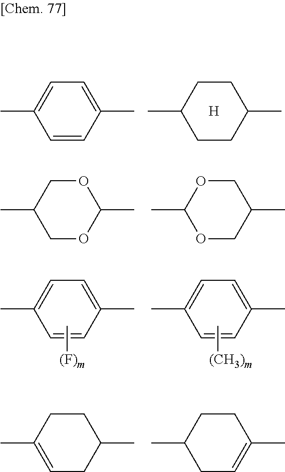

T¹, T², and T³ may be the same as or different from each other. In the above substituents, m represents an integer from 1 to 4.

T⁵ in Formula (II-y) represents a trivalent cyclic group such as a benzene-1,2,4-triyl group, a benzene-1,3,4-triyl group, a benzene-1,3,5-triyl group, a cyclohexane-1,2,4-triyl group, a cyclohexane-1,3,4-triyl group, or a cyclohexane-1,3,5-triyl group.

In Formulae (II-x) and (II-y), Y¹, Y², and Y⁴ each independently represent a linear or branched alkylene group having 1 to 10 carbon atoms; in such an alkylene group, one CH₂ group or two CH₂ groups not adjoining each other are optionally substituted with —O—, —S—, —CO—O—, or —O—CO—. Y¹ and Y² each optionally contain a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH═CHCH₂CH₂—, or —CH₂CH₂CH═CH—; Y¹ and Y² each optionally contain an asymmetric carbon atom; and Y¹ and Y² may be the same as or different from each other provided that they have any of the above-mentioned structures.

Y⁰ and Y³ each represent a single bond, —O—, —OCO—, or —COO—.

Z¹ represents an alkylene group having 3 to 20 carbon atoms, containing an asymmetric carbon atom, and having a branched chain structure.

Z² represents an alkylene group having 1 to 20 carbon atoms and optionally containing an asymmetric carbon atom.

The polymerizable compound used in the present invention may be any one of the compounds represented by the above-mentioned formulae (I), (II), (II-x), and (II-y) or may be a combination of at least two thereof.

In the case where the liquid crystal composition of the present invention contains a polymerizable compound, polymerization, such as radical polymerization, anionic polymerization, or cationic polymerization, can be carried out; in particular, radical polymerization is preferred.

A radical polymerization initiator to be used can be a thermal polymerization initiator or a photopolymerization initiator, and a photopolymerization initiator is preferred. In particular, preferred examples thereof include the following compounds:

acetophenone compounds such as diethoxyacetophenone, 2-hydroxy-2-methyl-1-phenylpropane-1-one, benzyldimethylketal, 1-(4-isopropylphenyl)-2-hydroxy-2-methylpropane-1-one, 4-(2-hydroxyethoxy)phenyl-(2-hydroxy-2-propyl)ketone, 1-hydroxycyclohexyl-phenylketone, 2-methyl-2-morpholino(4-thiomethylphenyl)propane-1-one, and 2-benzyl-2-dimethylamino-1-(4-morpholinophenyl)-butanone;

benzoyl compounds such as benzoin, benzoin isopropyl ether, and benzoin isobutyl ether;

acylphosphine oxides such as 2,4,6-trimethylbenzoyl diphenylphosphine oxide;

benzyl esters and methylphenylglyoxy esters;

benzophenone compounds such as benzophenone, methyl o-benzoylbenzoate, 4-phenylbenzophenone, 4,4′-dichlorobenzophenone, hydroxybenzophenone, 4-benzoyl-4′-methyl-diphenyl sulfide, acrylated benzophenone, 3,3′,4,4′-tetra(t-butylperoxycarbonyl)benzophenone, and 3,3′-dimethyl-4-methoxybenzophenone;

thioxanthone compounds such as 2-isopropylthioxanthone, 2,4-dimethylthioxanthone, 2,4-diethylthioxanthone, and 2,4-dichlorothioxanthone;

aminobenzophenone compounds such as Michler's ketone and 4,4′-diethylaminobenzophenone; and

10-butyl-2-chloroacridine, 2-ethylanthraquinone, 9,10-phenanthrenequinone, and camphorquinone. Among these compounds, benzyldimethylketal is most preferred.

In the present invention, in addition to the polymerizable liquid crystal compound (II), a polyfunctional liquid crystal monomer can be used. Examples of the polymerizable functional group of the polyfunctional liquid crystal monomer include an acryloyloxy group, a methacryloyloxy group, an acrylamide group, a methacrylamide group, an epoxy group, a vinyl group, a vinyloxy group, an ethynyl group, a mercapto group, a maleimide group, and RCH═CHCOO— (where R represents a fluorine atom or a hydrocarbon group having 1 to 18 carbon atoms). Among these, an acryloyloxy group, a methacryloyloxy group, an epoxy group, a mercapto group, and a vinyloxy group are preferred; a methacryloyloxy group and an acryloyloxy group are especially preferred; and an acryloyloxy group is most preferred.

The polyfunctional liquid crystal monomer has a molecular structure including a liquid crystal skeleton having two or more rings, a polymerizable functional group, and preferably at least two, more preferably three, flexible groups linking the liquid crystal skeleton to the polymerizable functional group. Examples of the flexible groups include alkylene spacer groups represented by —(CH₂)ₙ— (where n represents an integer) and siloxane spacer groups represented by —(Si(CH₃)₂—O)ₙ— (where n represents an integer). Among these, alkylene spacer groups are preferred.

The part at which the flexible groups are linked to the liquid crystal skeleton or the polymerizable functional group may have a bond such as —O—, —COO—, or —CO— for mediating the linkage.

<Liquid Crystal Display Device>

The liquid crystal composition of the present invention is used in liquid crystal display devices in which the polymerizable compound is polymerized by being irradiated with ultraviolet for alignment of liquid crystal molecules and in which the birefringence of the liquid crystal composition is utilized to control the amount of light that is to be transmitted. In the case where such a liquid crystal composition is a nematic liquid crystal composition, it is useful for liquid crystal display devices, such as an AM-LCD (active-matrix liquid crystal display device), a TN (nematic liquid crystal display device), an STN-LCD (super twisted nematic liquid crystal display device), an ECB-LCD, a VA-LCD, an FFS-LCD, an OCB-LCD, and an IPS-LCD (in-plane switching liquid crystal display device), particularly useful for an AM-LCD, and can be used in transmissive or reflective liquid crystal display devices. In the case where the liquid crystal composition is a ferroelectric liquid crystal composition that is in a smectic C* phase, it is usable in VA-LCDs, such as FFS and IPS-LCDs, and in LCDs of horizontal alignment, such as an SSF (surface-stabilized ferroelectric) LCD and a PSV (polymer-stabilized V-mode) FLCD.

Two substrates used in a liquid crystal cell included in a liquid crystal display device can be made of a transparent material having flexibility, such as glass or a plastic material, and one of these substrates may be made of a non-transparent material such as silicon. In order to form a transparent electrode layer on a transparent substrate such as a glass plate, for example, indium tin oxide (ITO) is sputtered on the transparent substrate.

Color filters can be produced by, for instance, a pigment dispersion technique, a printing technique, an electrodeposition technique, or a staining technique. In production of the color filters by, for example, a pigment dispersion technique, a curable colored composition for a color filter is applied onto the transparent substrate, subjected to patterning, and then cured by being heated or irradiated with light. This process is carried out for each of three colors of red, green, and blue, thereby being able to produce the pixels of the color filters. Active elements such as a TFT and a thin-film diode may be provided on the resulting substrate to form pixel electrodes.

The substrates are arranged so as to face each other with the transparent electrode layer interposed therebetween. In the arrangement of the substrates, a spacer may be present between the substrates to adjust the distance therebetween. In this case, the distance between the substrates is adjusted so that the thickness of a light modulating layer to be formed is preferably in the range of 1 to 100 μm, and more preferably 1.5 to 10 m. In the case where a polarizing plate is used, the product of the refractive index anisotropy Δn of liquid crystal and a cell thickness d is preferably adjusted for maximization of contrast so that it is ½ or ¼ of 550 nm on the basis of a display mode. In the case where two polarizing plates are used, the polarization axis of each polarizing plate may be adjusted to give a good viewing angle or contrast. Furthermore, a retardation film may be also used to increase a viewing angle. Examples of the spacer include columnar spacers made of, for instance, glass particles, plastic particles, alumina particles, or photoresist materials. A sealing material such as a thermosetting epoxy composition is subsequently applied to the substrates by screen printing in a state in which a liquid crystal inlet has been formed, the substrates are attached to each other, and then the sealing material is heated to be thermally cured.

The polymerizable-compound-containing liquid crystal composition can be put into the space between the two substrates by, for example, a vacuum injection technique or ODF technique which is generally employed. A vacuum injection technique, however, has a problem in which traces of the injection remain while droplet stains are not generated. The present invention can be more suitably applied to display devices manufactured by an ODF technique.

In a process for manufacturing a liquid crystal display device by an ODF technique, an optically and thermally curable epoxy-based sealing material is applied to any one of a backplane and a frontplane with a dispenser in the form of a closed loop that serves as a wall, a certain amount of the liquid crystal composition is dropped onto part of the substrate surrounded by the applied sealing material in a degassed atmosphere, and then the frontplane and the backplane are bonded to each other, thereby being able to manufacture a liquid crystal display device. The liquid crystal composition of the present invention can be stably dropped in an ODF process and can be therefore desirably used.

Since a proper polymerization rate is desired to enable liquid crystal molecules to be aligned in a good manner, the polymerizable compound is preferably polymerized by being irradiated with one of active energy rays, such as an ultraviolet ray and an electron beam, or by being irradiated with such active energy rays used in combination or in sequence. In the use of an ultraviolet ray, a polarized light source or a non-polarized light source may be used.

In the case where the polymerizable-compound-containing liquid crystal composition is polymerized in a state in which the composition has been disposed between the two substrates, at least the substrate on the side from which active energy rays are emitted needs to have transparency suitable for the active energy rays. Another technique may be used, in which only the intended part is polymerized by being irradiated with light with a mask, the alignment state of the non-polymerized part is subsequently changed by adjustment of conditions such as an electric field, a magnetic field, or temperature, and then polymerization is further carried out through irradiation with active energy rays. In particular, it is preferred that exposure to ultraviolet radiation be carried out while an alternating electric field is applied to the polymerizable-compound-containing liquid crystal composition. The alternating electric field to be applied preferably has a frequency ranging from 10 Hz to 10 kHz, and more preferably 100 Hz to 5 kHz; and the voltage is determined on the basis of a predetermined pretilt angle in a liquid crystal display device. In other words, the pretilt angle in a liquid crystal display device can be controlled by adjustment of voltage that is to be applied. In MVA-mode liquid crystal display devices which involve use of a horizontal electric field, a pretilt angle is preferably controlled to be from 80 degrees to 89.9 degrees in view of alignment stability and contrast.

The temperature in the irradiation procedure is preferably within a temperature range in which the liquid crystal state of the liquid crystal composition of the present invention can be maintained. Polymerization is preferably carried out at a temperature close to room temperature, i.e., typically from 15 to 35° C. Preferred examples of a lamp that is usable for emitting an ultraviolet ray include a metal halide lamp, a high-pressure mercury lamp, and an ultrahigh-pressure mercury lamp. In addition, an ultraviolet ray to be emitted preferably has a wavelength that is in a wavelength region different from the wavelength region of light absorbed by the liquid crystal composition; it is preferred that an ultraviolet ray in a particular wavelength range be cut off as needed. The intensity of an ultraviolet ray to be emitted is preferably from 0.1 mW/cm² to 100 W/cm², and more preferably 2 mW/cm² to 50 W/cm². The energy of an ultraviolet ray to be emitted can be appropriately adjusted: preferably from 10 mJ/cm² to 500 J/cm², and more preferably 100 mJ/cm² to 200 J/cm². The intensity may be changed in the exposure to ultraviolet radiation. The time of the exposure to ultraviolet radiation is appropriately determined on the basis of the intensity of an ultraviolet ray to be emitted: preferably from 10 seconds to 3600 seconds, and more preferably 10 seconds to 600 seconds.

Liquid crystal display devices using the liquid crystal composition of the present invention are practical because they quickly respond and are less likely to suffer from defective display at the same time; in particular, the liquid crystal composition is useful to active-matrix liquid crystal display devices.

### EXAMPLES

Although the present invention will now be described further in detail with reference to Examples, the present invention is not limited to Examples. In compositions which will be described in Examples and Comparative Examples, the term “%” refers to “mass %”.

In Examples and Comparative Examples, T_{Cryst}, T_{SmC*}, T_{SmC}, T_{SmA}, and T_{NI} are defined as follows.

T_{Cryst}: Crystallization temperature (° C.)

T_{SmC*}: Chiral smectic C* phase transition temperature (° C.)

T_{SmC}: Smectic C phase transition temperature (° C.)

T_{SmA}: Smectic A phase transition temperature (° C.)

T_{NI}: Nematic phase-isotropic liquid phase transition temperature (° C.)

Crystallization temperature and phase transition temperatures of each of liquid crystal compositions produced in Examples and Comparative Examples were measured with a polarizing microscope having a temperature-controlled stage and a differential scanning calorimeter (DSC) in combination.

In each of Examples 1 to 17, compounds represented by the following formulae were mixed with each other in predetermined amounts as shown in Tables 1 and 2 to produce a liquid crystal composition, and the crystallization temperature and phase transition temperatures thereof were measured. Tables 1 and 2 show temperatures obtained in the measurement.

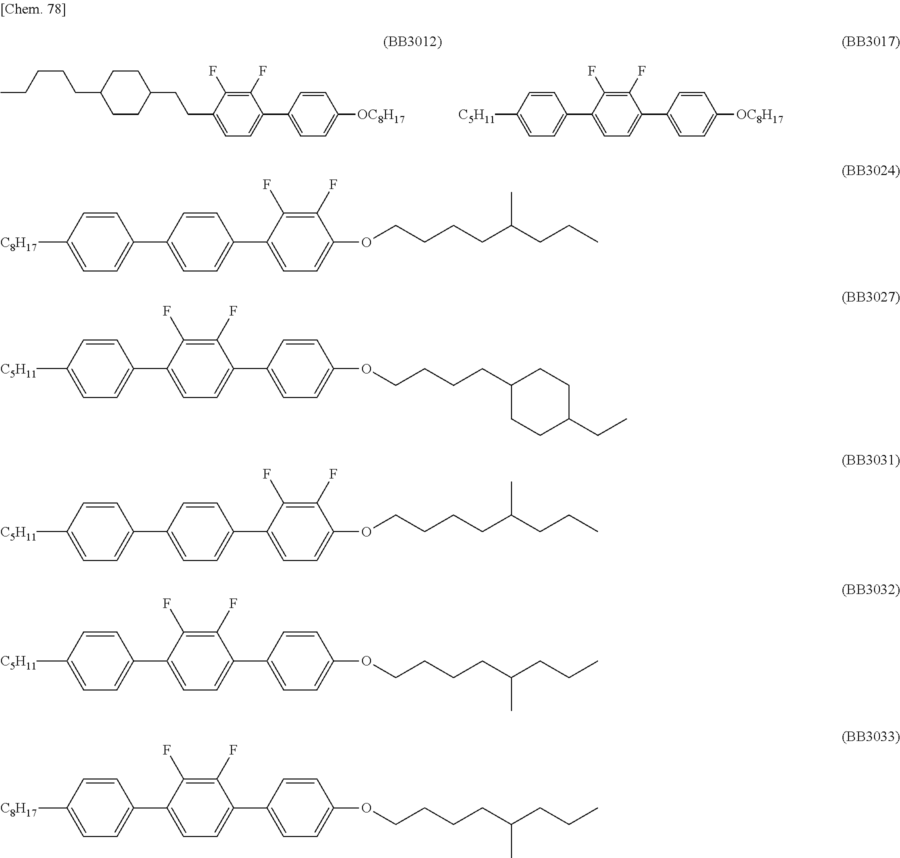

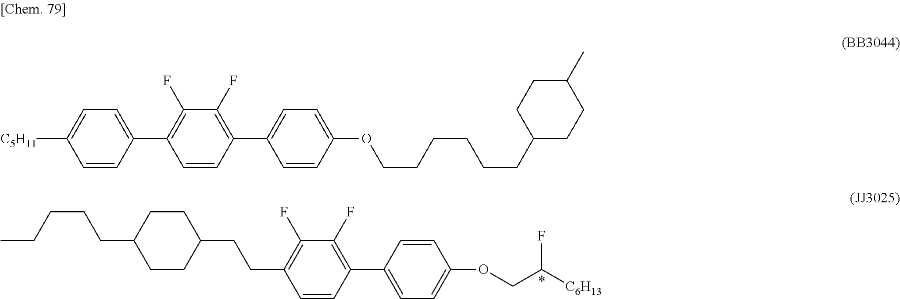

TABLE 1

| | Compound 1 | | Compound 2 | | | | | |
|---|---|---|---|---|---|---|---|---|
| | Name of | Content | Name of | Content | T_{Cryst} | T_{SmC} | T_{SmA} | T_{NI} |
| | compound | (mass %) | compound | (mass %) | (° C.) | (° C.) | (° C.) | (° C.) |
| Example 1 | BB3012 | 50 | BB3017 | 50 | −12.7 | 86.0 | 86.2 | 135.7 |
| Example 2 | BB3031 | 50 | BB3017 | 50 | 2.7 | 113.6 | — | 138.8 |
| Example 3 | BB3024 | 50 | BB3032 | 50 | −1.0 | 108.1 | — | 121.7 |
| Example 4 | BB3017 | 50 | BB3027 | 50 | −10.2 | 86.3 | — | 142.1 |
| Example 5 | BB3032 | 50 | BB3027 | 50 | −19.9 | 70.9 | — | 125.1 |
| Example 6 | BB3012 | 50 | BB3032 | 50 | −44.7 | 63.2 | — | 120.2 |
| Example 7 | BB3017 | 50 | BB3032 | 50 | −0.6 | 82.5 | — | 129.7 |
| Example 8 | BB3027 | 50 | BB3044 | 50 | −8 | 97.3 | — | 158.4 |
| Example 9 | BB3017 | 40 | BB3012 | 20 | −31.4 | 80.6 | — | 133.3 |
| | BB3027 | 20 | BB3032 | 20 | | | | |
| Example 10 | BB3017 | 20 | BB3032 | 20 | −42 | 101.1 | — | 138.0 |
| | BB3027 | 20 | BB3024 | 20 | | | | |
| | BB3044 | 20 | | | | | | |
| Example 11 | BB3012 | 35 | BB3032 | 35 | −38.2 | 78.7 | — | 137.1 |
| | BB3044 | 30 | | | | | | |
| Example 12 | BB3012 | 25 | BB3032 | 25 | −40.5 | 100.7 | — | 135.3 |
| | BB3024 | 25 | BB3044 | 25 | | | | |
| Example 13 | BB3017 | 40 | BB3032 | 30 | −31.0 | 109.4 | | 136.5 |
| | BB3033 | 30 | | | | | | |

TABLE 2

| | Compound 1 | | Compound 2 | | | | | |
|---|---|---|---|---|---|---|---|---|
| | Name of | Content | Name of | Content | T_{Cryst} | T_{SmC} | T_{SmA} | T_{NI} |
| | compound | (mass %) | compound | (mass %) | (° C.) | (° C.) | (° C.) | (° C.) |
| Example 14 | BB3012 | 35 | BB3032 | 35 | −27.6 | 95.2 | — | 121.0 |
| | BB3033 | 30 | | | | | | |
| Example 15 | BB3012 | 25 | BB3017 | 25 | −45.4 | 96.9 | — | 126.5 |
| | BB3024 | 25 | BB3032 | 25 | | | | |
| Example 16 | BB3012 | 22.5 | BB3017 | 22.5 | −45.2 | 97.7 | 102.0 | 128.4 |
| | BB3024 | 22.5 | BB3032 | 22.5 | | (T_{SmC}*) | | |
| | JJ3025 | 10 | | | | | | |
| Example 17 | BB3012 | 17 | BB3032 | 17 | −37.6 | 101.8 | 111.4 | 134.5 |
| | BB3024 | 25 | BB3044 | 25 | | (T_{SmC}*) | | |
| | JJ3025 | 15 | | | | | | |

As shown in Table 1, in each of Examples 1 to 8, a compound having a pyrimidine skeleton was not used, but at least two liquid crystal compounds each containing a mesogenic group having three or more rings of which at least one was a 2,3-difluorobenzene-1,4-diyl group and two terminal groups having different structures were used, which enabled production of a liquid crystal composition of which the crystallization temperature was low and in which the upper limit of the temperature of a smectic C phase was high, in other words, the temperature range of the smectic C phase was wide.

As shown in Table 1, in each of Examples 2 and 3, a 2′,3′-difluoroterphenyl derivative and a 2,3-difluoroterphenyl derivative having a terminal group that was different from at least one of the two terminal groups of the 2′,3′-difluoroterphenyl derivative were used in combination to make the crystallization temperature being 3° C. or less, thereby producing a binary composition in which the temperature range of a smectic C* phase had been expanded.

As shown in Table 1, in each of Examples 4 to 7, a 2′,3′-difluoroterphenyl derivative and another 2′,3′-difluoroterphenyl derivative having a terminal group that was different from at least one of the two terminal groups of the 2′,3′-difluoroterphenyl derivative and that had 7 or more carbon atoms were used in combination to make the crystallization temperature being 3° C. or lower and the upper limit of the temperature of a smectic C phase being 100° C. or more, thereby producing a binary composition in which the temperature range of the smectic C phase had been expanded.

As shown in Tables 1 and 2, in each of Examples 9 to 15, using 3 to 5 components enabled the crystallization temperature to be −27° C. or less, which enabled further expansion of the temperature range of a smectic C phase. In each case, this was brought about by combined use of multiple compounds having a difference in the structures of the terminal groups.

As shown in Table 2, in Example 16, addition of 10% of a chiral liquid crystal compound JJ3025 to the composition of Example 15 that exhibited a smectic C phase led to generation of a smectic C* phase having a temperature range from −45.2° C. to 97.7° C., and the composition showed ferroelectricity at spontaneous polarity of 14.1 nC/cm² at 25° C. As shown in Table 1, in Example 17, addition of 15% of a chiral liquid crystal compound JJ3025 to the composition of Example 12 that exhibited a smectic C phase led to generation of a smectic C* phase having a temperature range from −37.6° C. to 101.8° C., and the composition showed ferroelectricity at spontaneous polarity of 21.5 nC/cm² at 25° C.

In each of Comparative Examples 1 to 7, two compounds represented by any of the above formulae and below formulae were mixed with each other individually in an amount of approximately 50 mass % as shown in Table 3 to produce a liquid crystal composition. Furthermore, in each of Comparative Examples 8 to 23, a compound represented by any of the above formulae and below formulae was used alone, and then the temperatures thereof were measured. Table 3 shows temperatures obtained in the measurement.

TABLE 3

| | Compound 1 | Compound 2 | T_{Cryst} | T_{SmC} | T_{SmA} | T_{NI} |
|---|---|---|---|---|---|---|
| Comparative | BB2013 | BB3017 | 8.7 | 65.8 | 71.1 | 87.6 |
| Example 1 | | | | | | |
| Comparative | BB2013 | BB3024 | 32.6 | 87.1 | — | — |
| Example 2 | | | | | | |
| Comparative | BB2013 | BB3012 | 19.0 | 41.9 | 70.7 | 83.4 |
| Example 3 | | | | | | |
| Comparative | BB2013 | BB3012 | 25.4 | — | 38.0 | — |
| Example 4 | | | | | | |
| Comparative | BB2010 | BB3017 | 21.0 | 38.7 | 94.1 | — |
| Example 5 | | | | | | |
| Comparative | BB2001 | BB3016 | 45.3 | — | — | 88.9 |
| Example 6 | | | | | | |
| Comparative | BB2009 | BB3006 | 4.4 | 39.7 | 65.3 | 83.5 |
| Example 7 | | | | | | |
| Comparative | BB2001 | — | — | — | — | 32 |
| Example 8 | | | | | | |
| Comparative | BB2009 | — | 40 | 41 | — | — |
| Example 9 | | | | | | |
| Comparative | BB2010 | — | 55 | 60 | — | — |
| Example 10 | | | | | | |
| Comparative | BB2012 | — | 41 | — | 35 | — |
| Example 11 | | | | | | |
| Comparative | BB2013 | — | 47 | — | 40 | — |
| Example 12 | | | | | | |
| Comparative | BB3006 | — | 73 | 73.5 | 94 | 141 |
| Example 13 | | | | | | |
| Comparative | BB3012 | — | 35 | 70 | 103 | 127 |
| Example 14 | | | | | | |
| Comparative | BB3016 | — | 92 | 144 | 148 | 159 |
| Example 15 | | | | | | |
| Comparative | BB3017 | — | 52.7 | 97 | — | 143 |
| Example 16 | | | | | | |
| Comparative | BB3024 | — | 62 | 129 | — | — |
| Example 17 | | | | | | |
| Comparative | BB3027 | — | 74 | 80 | — | 136 |
| Example 18 | | | | | | |
| Comparative | BB3031 | — | 118 | 129 | 131 | 136 |
| Example 19 | | | | | | |
| Comparative | BB3032 | — | 40 | 67 | — | 111 |
| Example 20 | | | | | | |
| Comparative | BB3033 | — | 62 | 130 | — | — |
| Example 21 | | | | | | |
| Comparative | BB3044 | — | 87 | 116 | — | 172 |
| Example 22 | | | | | | |
| Comparative | BB3025 | — | 44 | — | 115 | 124 |
| Example 23 | | | | | | |

As shown in Table 3, in Comparative Examples 1 to 7, typical bicyclic liquid crystal compounds were used to decrease the crystallization temperature of a liquid crystal composition. In particular, in each of Comparative Examples 1 to 4, a binary composition containing a 2,3-difluorobiphenyl derivative was used. In each of Comparative Examples 1 to 7, the composition had a high crystallization temperature of not less than 4° C. and a narrower temperature range from the crystallization temperature to a smectic C* phase transition temperature than the compositions of Examples 1 to 7.

As shown in Table 3, in each of Comparative Examples 8 to 23 in which a bicyclic liquid crystal compound or a tricyclic liquid crystal compound was used alone, the composition had a high crystallization temperature of not less than 40° C. and a narrower temperature range from the crystallization temperature to a smectic C* phase transition temperature than the compositions of Examples 1 to 7.

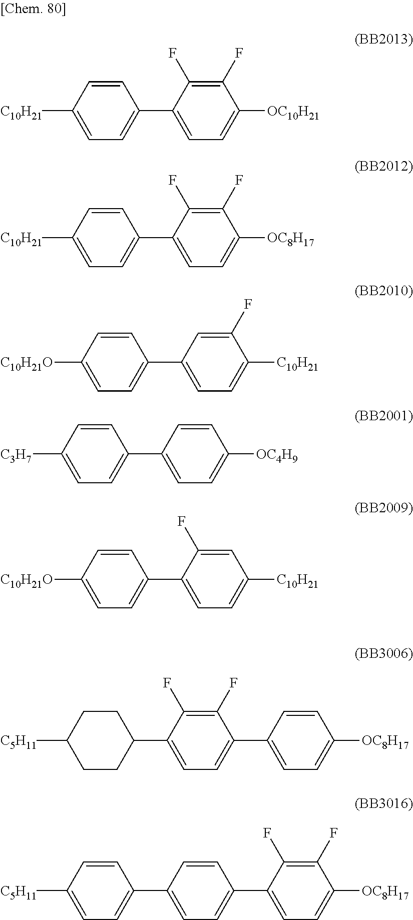

### Example 18

### Production and Evaluation of Polymer-Stabilized Ferroelectric Liquid Crystal Display Device

The polymer-stabilized ferroelectric liquid crystal display device of this example was produced as follows.

A polymer-stabilized ferroelectric liquid crystal composition shown in Table 4 was heated to a nematic phase transition temperature or more and then injected by vacuum injection. In order to uniaxially align (homogeneously align) liquid crystal molecules, the cell used was an ITO-provided cell which had a cell gap of 2.5 μm, to which a polyimide alignment film (RN-1199 manufactured by Nissan Chemical Industries, Ltd.) had been applied, and which had been subjected to rubbing in a parallel direction.

The liquid crystal composition shown in Table 4 had the following temperatures.

T_{Cryst}: −37.6 (° C.)

T_{SmC*}: 106 (° C.)

T_{SmA}: 119.8 (° C.)

T_{NI}: 148.3 (° C.)

Materials for forming a light-modulating layer, which included the ferroelectric liquid crystal composition, a radical polymerizable composition, a photopolymerization initiator, and a slight amount of a polymerization inhibitor, were put into a glass cell by vacuum injection. The degree of vacuum was 2 Pa. The glass cell was taken out after the injection, and the injection inlet was sealed with a sealant 3026E (manufactured by ThreeBond Holdings Co., Ltd.). Then, the cell was observed with a crossed-Nicols polarizing microscope to find biaxial alignment. The product was subsequently exposed to light having a wavelength of 365 nm with a UV-LED array under switching by application of a square wave at a frequency of 350 Hz and a voltage of 10 V. The exposure to light was carried out over 600 seconds at radiation intensity adjusted to be 5 mW/cm² on a surface of the cell sample in order to polymerize the polymerizable compound contained in the polymer-stabilized liquid crystal composition, thereby producing a polymer-stabilized ferroelectric liquid crystal display device of uniaxial alignment.

The application of voltage in the exposure to ultraviolet was terminated, and then the cell sample exposed to ultraviolet was observed with a polarizing microscope to find uniaxial alignment and observed under rotation of the sample stage of the microscope to find the direction of polarization in a dark field in crossed Nicols. For voltage-light transmittance properties, the uniaxial direction of the device was aligned with the direction of polarization to give a dark field, and a square field of 60 Hz was applied to measure the intensity of transmitted light with a photomultiplier attached to the body tube of the microscope. The light transmittance was adjusted to be 0% when two polarization plates were placed orthogonal to each other and 100% when the polarization plates were put in parallel. In voltage-light transmittance properties, a voltage necessary to cause 90% change in light transmittance relative to light transmittance given by application of saturation voltage (10 Vo-p) was defined as V90 to evaluate driving voltage. Light transmittance given by application of saturation voltage was defined as maximum light transmittance T100, and light transmittance at a voltage of 0 Vo-p was defined as minimum transmittance T0. Contrast was defined as T0/T100.

<Voltage-Light Transmittance Properties of Produced Cell>

Observation with a polarizing microscope showed that darkness given by uniaxial alignment was able to be found at the part corresponding to the cell electrode; voltage-light transmittance properties were measured, and symmetric V-shaped voltage-light transmittance properties were obtained.

### T0: 0.06%

### T100: 61%

### T0/T100: 1017

### V90: 9.7 V

TABLE 4

| Structural formula | Content (mass %) |
|---|---|
| 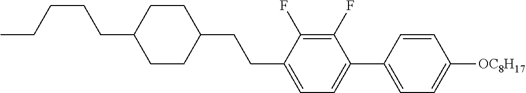 | 12.9 |
| 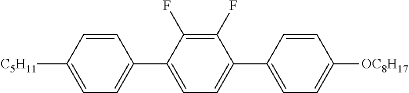 | 35.5 |
| 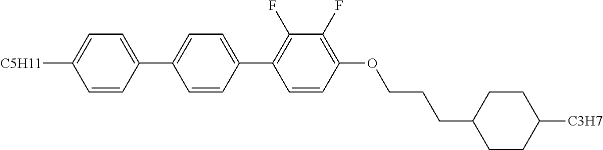 | 11.8 |
| 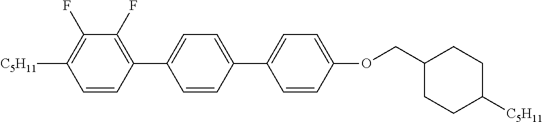 | 2.9 |
| 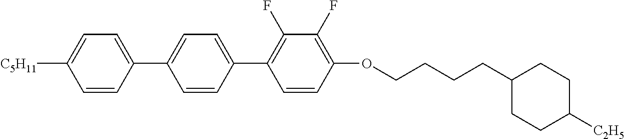 | 11.8 |
| 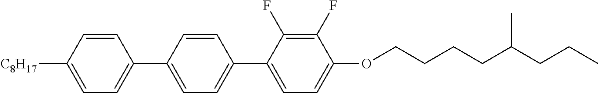 | 8.9 |
| 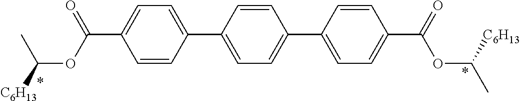 | 1.7 |
| 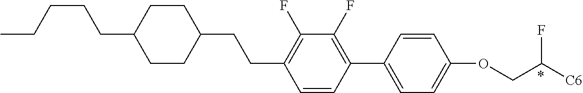 | 13.1 |
| 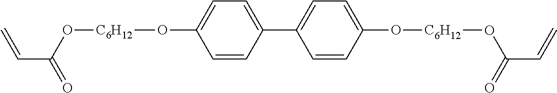 | 1.37 |
| 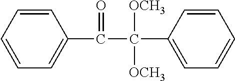 [SMILES: COC(OC)(C(=O)c1ccccc1)c1ccccc1] | 0.03 |

1. A liquid crystal composition comprising at least two liquid crystal compounds each containing a mesogenic group having at least three rings of which at least one is a 2,3-difluorobenzene-1,4-diyl group and two terminal groups having different structures, wherein a compound having a pyrimidine skeleton is not used.

2. The liquid crystal composition according to claim 1, wherein the mesogenic group of each of the liquid crystal compounds is represented by General Formula (I)
-(A¹-Z¹)ₘ-(A²-Z²)ₙ-A²- (I)
(where, A¹, A², and A³ each independently represent a 2,3-difluorobenzene-1,4-diyl group, a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, or a fluorene-2,7-diyl group;
at least one of A¹, A², and A³ represents a 2,3-difluorobenzene-1,4-diyl group;
the 1,4-phenylene group, the 1,2,3,4-tetrahydronaphthalene-2,6-diyl group, the 2,6-naphthylene group, the phenanthrene-2,7-diyl group, the 9,10-dihydrophenanthrene-2,7-diyl group, the 1,2,3,4,4a,9,10a-octahydrophenanthrene-2,7-diyl group, and the fluorene-2,7-diyl group each optionally have at least one of F, CF₃, OCF₃, and CH₃ as a substituent;
Z¹ and Z² each independently represent —O—, —CO—, —COO—, —CF₂O—, —OCF₂—, —OCO—, —CH₂CH₂—, —O—CH₂—, —CH₂O—, —CH═CH—, —C≡C—, —CF₂CF₂—, or a single bond; and
n and m each represent 1 or 2).

3. The liquid crystal composition according to claim 1, wherein the mesogenic group of each of the liquid crystal compounds is at least one selected from the group consisting of a 2′,3′-difluoroterphenyl group, a 2,3-difluoroterphenyl group, and a 2″,3″-difluoroterphenyl group.

4. The liquid crystal composition according to claim 1, wherein a liquid crystal compound containing a 2′,3′-difluoroterphenyl group as the mesogenic group and a liquid crystal compound containing a 2,3-difluoroterphenyl group as the mesogenic group are used, and
the liquid crystal compound containing a 2′,3′-difluoroterphenyl group and the liquid crystal compound containing a 2,3-difluoroterphenyl group have a difference in at least one of the two terminals each other.

5. The liquid crystal composition according to claim 1, wherein at least two liquid crystal compounds each containing a 2′,3′-difluoroterphenyl group as the mesogenic group are used.

6. The liquid crystal composition according to claim 1, wherein the terminal groups of each of the liquid crystal compounds are each a hydrogen atom or a linear or branched alkyl group having 1 to 20 carbon atoms; one —CH₂— moiety or at least two —CH₂— moieties not adjoining each other in the alkyl group are each independently optionally substituted with —CH═CH—, —C≡C—, —O—, —CO—, —COO—, —OCO—, or a cyclohexylene group; one or more hydrogen atoms in the alkyl group are each independently optionally substituted with a fluorine atom; and
among the —CH₂— moieties of the terminal groups, a —CH₂— moiety which is distant from the mesogenic group with at least four atoms interposed between them is optionally substituted with a 1,4-cyclohexylene group, a 1,4-phenylene group, a 1,4-bicyclo(2,2,2)octylene group, or a dialkylsilylene group.

7. The liquid crystal composition according to claim 6, wherein at least one of the terminal groups of each of the liquid crystal compounds is an alkyl group having 4 to 15 carbon atoms or an alkoxyl group having 4 to 15 carbon atoms.

8. The liquid crystal composition according to claim 1, wherein the composition exhibits a smectic phase as a liquid crystal phase.

9. The liquid crystal composition according to claim 1, further comprising at least one compound containing an optically active substance.

10. The liquid crystal composition according to claim 1, further comprising at least one compound having a polymerizable functional group.

11. A liquid crystal display device comprising the composition according to claim 1.
